(19) United States
(12) Patent Application Publication
(10) Pub. No.: US 2017/0280441 A1
(43) Pub. Date: Sep. 28, 2017

(54) TERMINAL DEVICE, BASE STATION APPARATUS, AND COMMUNICATIONS METHOD

(71) Applicant: Sharp Kabushiki Kaisha, Sakai City, Osaka (JP)

(72) Inventors: Kazuyuki SHIMEZAWA, Sakai City, Osaka (JP); Kimihiko IMAMURA, Sakai City, Osaka (JP); Wataru OUCHI, Sakai City, Osaka (JP); Naoki KUSASHIMA, Sakai City, Osaka (JP); Alvaro RUIZ DELGADO, Sakai City, Osaka (JP); Takashi HAYASHI, Sakai City, Osaka (JP)

(73) Assignee: Sharp Kabushiki Kaisha, Sakai City, Osaka (JP)

(21) Appl. No.: 15/506,142

(22) PCT Filed: Sep. 25, 2015
(86) PCT No.: PCT/JP2015/077078

§ 371 Date: Feb. 23, 2017

(30) Foreign Application Priority Data
Sep. 26, 2014 (JP) 2014-196213

(51) Int. Cl. H04W 72/04; H04W 52/44

(52) U.S. Cl. CPC H04W 72/0413; H04W 72/0446; H04W 52/44; H04W 88/02

(57) ABSTRACT

Provided is a terminal device that communicates with a base station apparatus using a first cell group and a second cell group. The terminal device includes a higher-layer processing unit that sets guarantee power in the first cell group and guarantee power in the second cell group. In a case where a radio link failure occurs in a serving cell belonging to the second cell group, the guarantee power in the first cell group and/or the guarantee power in the second cell group are changed.

### TECHNICAL FIELD

Embodiments of the present invention relate to a technology relating to a terminal device, a base station apparatus, and a communication method capable of realizing effective channel state information sharing.

This application is based upon and claims the benefit of priority from Japanese Patent Application No. 2014-196213 filed in the Japan Patent Office on Sep. 26, 2014, the entire contents of which are incorporated herein by reference.

### BACKGROUND ART

In the 3rd Generation Partnership Project (3GPP) which is a standardization project, standardization of Evolved Universal Terrestrial Radio Access (hereinafter, referred to as EUTRA) realizing high speed communication was conducted by adopting an Orthogonal Frequency-Division Multiplexing (OFDM) communication scheme or flexible scheduling of prescribed frequency-time units called resource blocks.

The 3GPP reviews Advanced EUTRA realizing higher data transfer and having upper compatibility with the EUTRA. In the EUTRA, although a communication system based on a network composed of base station apparatuses having almost the same cell configuration (cell size) was reviewed, in the Advanced EUTRA, a communication system based on a network (heterogeneous wireless network, (Heterogeneous Network)) in which base station apparatuses (cells) having different configurations are mixed in the same area is reviewed.

As in the heterogeneous network, in a communication system in which a cell (macro cell) with a larger cell radius and a cell (small cell) with a cell radius smaller than that of the macro cell are arranged, dual connectivity technology in which a terminal device simultaneously connects to the macro cell and the small cell and makes communication is reviewed (NPL 1).

In NPL 1, a review of a network based on matters that when the terminal device is intended to realize dual connectivity between the cell (macro cell) with a large cell radius (cell size) and the cell (small cell (or, picocell)) with a small cell radius, backbone lines (Backhaul) between the macro cell and the small are low-speed lines and latency occurs between the cells is under way. That is, an exchange of control information or user information between the macro cell and the small cell is delayed and accordingly, there is a possibility that a function able to be realized in the conventional technology is unable to be realized or realization of the function becomes difficult.

In NPL 2, a method in which channel state information is fed back in the cell when the terminal device simultaneously connects to a plurality of cells connected with high-speed backhaul is described.

### CITATION LIST

### Non Patent Document

[NON PATENT DOCUMENT 1] NPL 1: R2-130444, NTT DOCOMO, 3GPP TSS RAN2#81, Jan. 28th-Feb. 1, 2013.

[NON PATENT DOCUMENT 2] NPL 2: 3rd Generation Partnership Project; Technical Specification Group Radio Access Network; Evolved Universal Terrestrial Radio Access (E-UTRA); Physical layer procedures (Release 10), February 2013, 3GPP TS 36. 213 V11. 2.0 (2013-2)

### DISCLOSURE OF THE INVENTION

### Problems to be Solved by the Invention

When a terminal device simultaneously connects to a plurality of cells connected with high-speed backhaul, the terminal device is able to collectively control transmit power in respective cells to a base station apparatus. However, in a case where dual connectivity that supports low-speed backhaul is used, information sharing between cells is limited and thus, it is unable to use a conventional transmit power control method as it is.

The present invention provides a terminal device, a base station apparatus, and a communication method that are capable of efficiently performing transmit power control.

### Means for Solving the Problems

(1) The present invention provides the following means. That is, a terminal device according to an aspect of the present invention is a terminal device that communicates with a base station apparatus and includes a higher layer processing unit setting a first cell group and a second cell group and an uplink sub-frame generation unit forming a physical uplink channel in the first cell group that overlaps the second cell group in a certain sub-frame. In a case where a Radio Link Failure (RLF) is detected in the second cell group, the higher layer processing unit performs prescribed processing to the physical uplink channel in the second cell group.

(2) The terminal device according to an aspect of the present invention is the terminal device described above and the prescribed processing releases settings in the second cell group.

(3) The terminal device according to an aspect of the present invention is the terminal device described above and the prescribed processing makes power of the physical uplink channel 0.

(4) The base station apparatus according to an aspect of the present invention is a base station apparatus that communicates with a terminal device and includes a higher layer processing unit setting a first cell group and a second cell group in the terminal device and an uplink sub-frame generation unit forming a physical uplink channel in the first cell group that overlaps the second cell group in a certain sub-frame. In a case where a Radio Link Failure (RLF) is detected in the second cell group, the higher layer processing unit performs prescribed processing to the physical uplink channel in the second cell group.

(5) The base station apparatus according to an aspect of the present invention is the base station apparatus described above and the prescribed processing releases settings in the second cell group.

(6) The base station apparatus according to an aspect of the present invention is the base station apparatus described above and the prescribed processing makes power of the physical uplink channel 0.

(7) A communication method according to an aspect of the present invention is a communication method used by a terminal device that communicates with a base station apparatus and includes a step of setting a first cell group and a second cell group and a step of forming a physical uplink channel in the first cell group that overlaps the second cell group in a certain sub-frame, and in a case where a Radio Link Failure (RLF) is detected in the second cell group, the higher layer processing unit performs prescribed processing to the physical uplink channel in the second cell group.

(8) A communication method according to an aspect of the present invention is a communication method used by a base station apparatus that communicates with a terminal device and includes a step of setting a first cell group and a second cell group in the terminal device and a step of forming a physical uplink channel in the first cell group that overlaps the second cell group in a certain sub-frame, and in a case where a Radio Link Failure (RLF) is detected in the second cell group, the higher layer processing unit performs prescribed processing to the physical uplink channel in the second cell group.

### Effects of the Invention

According to the present invention, it is possible to enhance transmission efficiency in a radio communication system in which a base station apparatus and a terminal device perform communication.

### BRIEF DESCRIPTION OF THE DRAWINGS

FIG. 1 is a diagram illustrating an example of a configuration of downlink radio frame according to a first embodiment.

FIG. 2 is a diagram illustrating an example of a configuration of uplink radio frame according to the first embodiment.

FIG. 3 is a diagram illustrating a basic architecture of dual connectivity according to the first embodiment.

FIG. 4 is a diagram illustrating a basic architecture of dual connectivity according to the first embodiment.

FIG. 5 is a diagram illustrating an example of a configuration of blocks of a base station apparatus according to the first embodiment.

FIG. 6 is a diagram illustrating an example of a configuration of blocks of a terminal device according to the first embodiment.

FIG. 7 is a diagram illustrating an example of a connectivity group according to the first embodiment.

FIG. 8 is a diagram illustrating an example of generation and reporting of CSI in the connectivity group according to the first embodiment.

FIG. 9 is a diagram illustrating an example of periodic CSI reporting according to the first embodiment.

FIG. 10 is a diagram illustrating an example of a configuration of blocks of a terminal device according to a second embodiment.

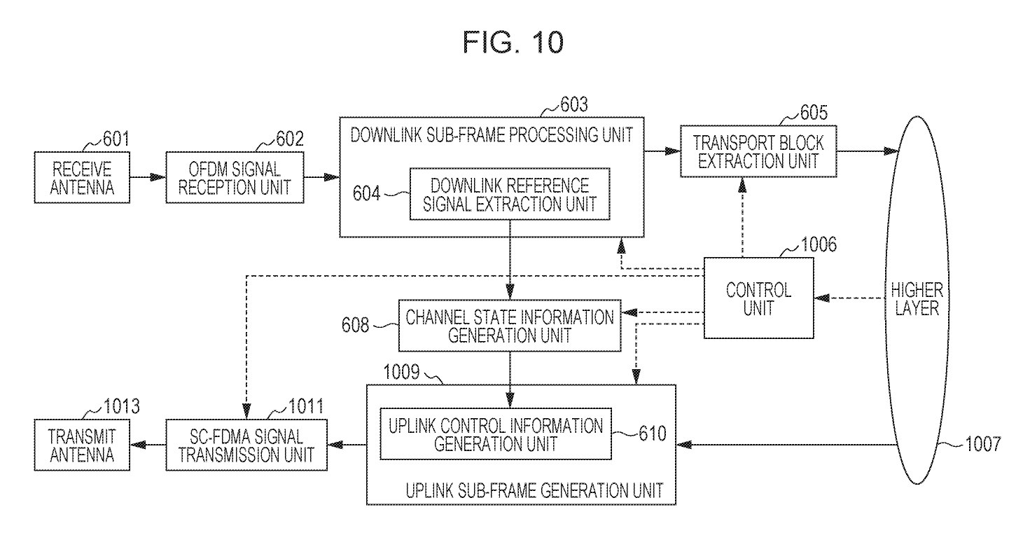

FIG. 11 is a diagram illustrating an example of periodic CSI reporting according to the second embodiment.

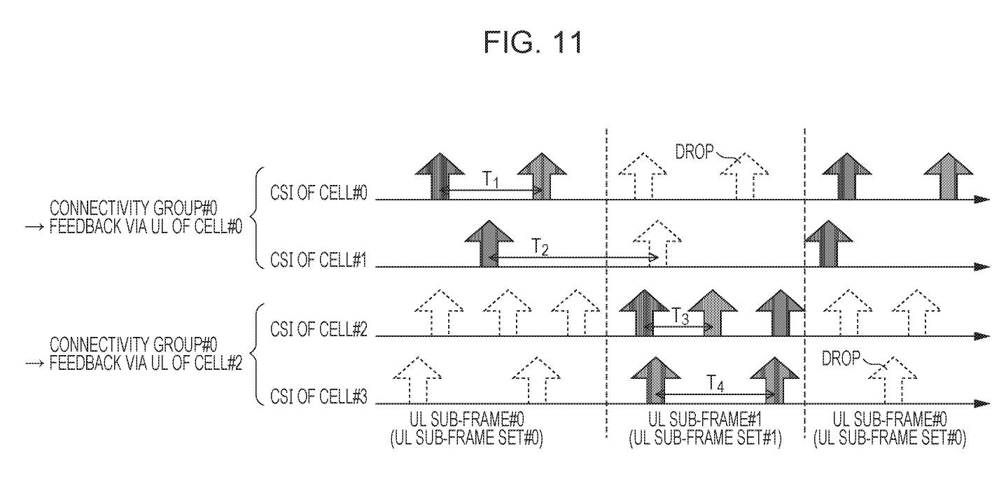

FIG. 12 is a diagram illustrating an example of an uplink transmission sub-frame in dual connectivity.

### MODE FOR CARRYING OUT THE INVENTION

### First Embodiment

A first embodiment of the present invention will be described in the following. Description will be made using a communication system (cellular system) in which a base station apparatus (base station, node B, eNB (eNodeB)) performs communication with a terminal device (terminal, mobile station, user device, User equipment (UE)) in a cell.

Description will be made mainly on a physical channel and a physical signal used in the EUTRA and Advanced EUTRA.

A channel means a medium used in transmission of a signal and a physical channel means a physical medium used in transmission of a signal. In the present embodiment, the physical channel and a signal may be used synonymously. In the EUTRA and Advanced EUTRA, although the physical channel may possibly be added or a structure or format of the physical channel may possibly be change or added in the future, even in a case of such change or addition being changed or added, description of the present embodiment is not influenced.

In the EUTRA and Advanced EUTRA, scheduling of the physical channel or the physical signal is managed using a radio frame. 1 radio frame is 10 ms and 1 radio frame is constituted with 10 sub-frames. Furthermore, 1 sub-frame is constituted with 2 slots (that is, 1 sub-frame is 1 ms and 1 slot is 0.5 ms). The scheduling is managed using a resource block for which the physical channel is assigned and which is used as a minimum unit of scheduling. The resource block is defined by a fixed frequency domain constituted with a set of a plurality of sub-carriers (for example, 12 sub-carriers) in a frequency axis and a domain constituted with a fixed transmission time interval (1 slot).

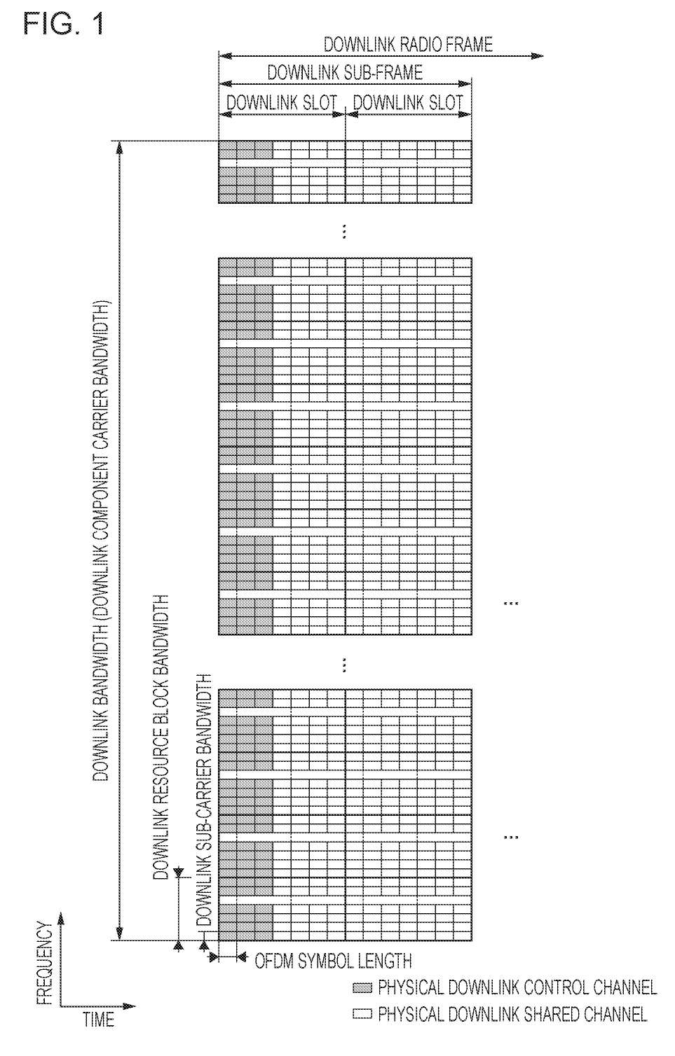

FIG. 1 is a diagram illustrating an example of a configuration of downlink radio frame according to the present embodiment. An OFDM access scheme is used for downlink. In the downlink, PDCCH, EPDCCH, a physical downlink shared channel (PDSCH) and the like are assigned. The downlink radio frame is constituted with a pair of downlink resource blocks (RBs). The downlink RB pair is unit of assignment of downlink radio resources or the like and is composed of a frequency band having a prescribed width (RB bandwidth) and a time duration (2 slots=1 sub-frame). 1 downlink RB pair is constituted with 2 downlink RBs (RB bandwidth×slot) that are continuous in the time domain. 1 downlink RB is constituted with 12 sub-carrier in the frequency domain. In the time domain, 1 downlink RB pair is constituted with 7 OFDM symbols in a case where a normal cyclic prefix is attached and 6 OFDM symbols in a case where a cyclic prefix longer than the normal cyclic prefix is attached. A region defined by 1 sub-carrier in the frequency domain and 1 OFDM symbol in the time domain is called a resource element (RE). The physical downlink control channel is a physical channel on which downlink control information such as a terminal device identifier, scheduling information of physical downlink shared channel, scheduling information of physical uplink shared channel, modulation scheme, coding rate, retransmission parameter, and the like are transmitted. Here, although a single downlink sub-frame is described in a single component carrier (CC), a downlink sub-frame is defined for each CC and downlink sub-frames are approximately synchronized between the CCs.

Here, although not illustrated, synchronization signals or physical information channel, or a downlink reference signal (RS) may also be assigned in the downlink sub-frame. As the downlink reference signal, there are a cell-specific reference signal (CRS) transmitted on the same transmission port as PDCCH, a channel state information reference signal (CSI-RS) used for measurement of channel state information (CSI), a terminal-specific reference signal (UE-specific RS (URS)) transmitted on the same transmission port as some of PDSCHs, a reference signal for demodulation (Demodulation RS: DMRS) transmitted on the same transmission port as EPDCCH and the like. It may also be a carrier on which the CRS is not assigned. In this case, a signal (referred to as enhanced synchronization signal) similar to a signal correspond to some of transmission ports (for example, only transmission port 0) or all of transmission ports of the CRS can be inserted into some of sub-frames (for example, first and sixth sub-frames in the radio frame) as a time and/or frequency tracking signal.

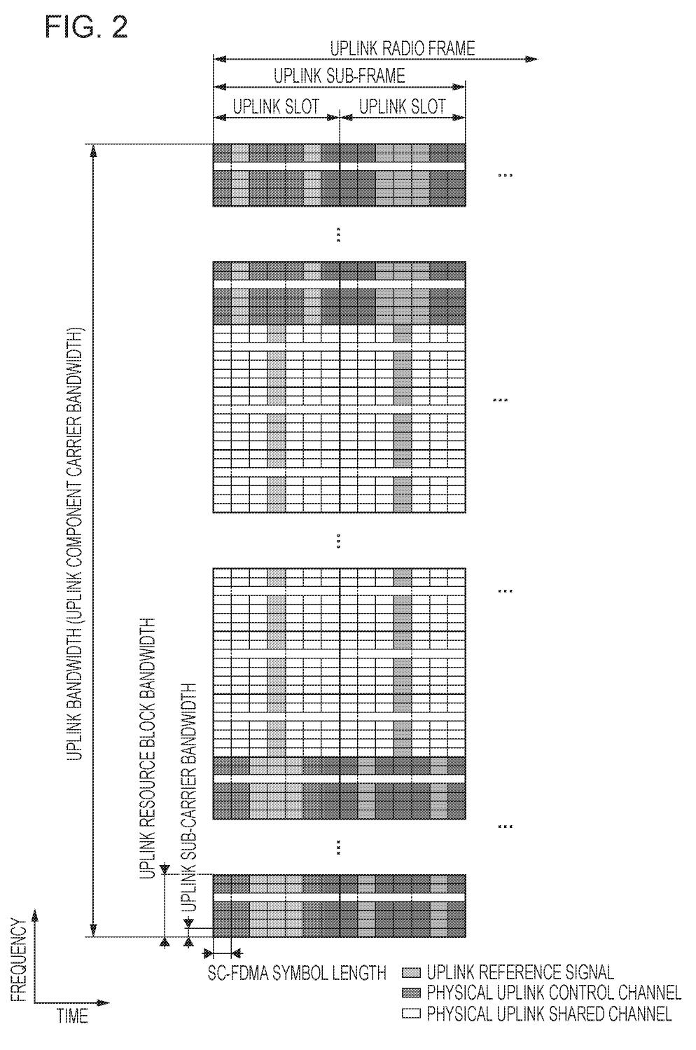

FIG. 2 is a diagram illustrating an example of a configuration of uplink radio frame according to the present embodiment. An SC-FDMA scheme is used for uplink. In the uplink, a physical uplink shared channel (PUSCH), PUCCH and like are assigned. An uplink reference signal is assigned to some of PUSCHs or PUCCHs. The uplink radio frame is constituted with a pair of uplink RBs. The uplink RB pair is unit of allocation of uplink radio resources or the like and is composed of a frequency band having a prescribed width (RB bandwidth) and a time duration (2 slots=1 sub-frame). 1 uplink RB pair is constituted with 2 uplink RBs (RB bandwidth×slot) that are continuous in the time domain. 1 uplink RB is constituted with 12 sub-carrier in the frequency domain. In the time domain, 1 uplink RB pair is constituted with 7 SC-FDMA symbols in a case where a normal cyclic prefix is attached and 6 SC-FDMA symbols in a case where a cyclic prefix longer than the normal cyclic prefix is attached. Here, although a single uplink sub-frame is described in a single CC, an uplink sub-frame is defined for each CC.

Synchronization signals are constituted with three types of primary synchronization signals and secondary synchronization signals constituted with 31 types of codes interleaved in the frequency domain, and a cell identifier (physical cell identity (ID) (PCI)) as in 504 identifying the base station apparatus and the frame timing for radio synchronization by a combination of the primary synchronization signal and the secondary synchronization signal are indicated. The terminal device specifies a physical cell ID of the received synchronization signal by a cell search.

The physical broadcast information channel (physical broadcast channel: PBCH) allows a control parameter (broadcast information (system information)) used in common by the terminal devices within a cell to be transmitted for the purpose of notification (setting). The radio resource to which broadcast information is notified through the physical downlink control channel is notified to the terminal device within the cell and for broadcast information not notified through the physical broadcast information channel, a layer 3 message (system information) that notifies broadcast information through the physical downlink shared channel is transmitted in the notified radio resource.

As the broadcast information, a cell global identifier (CGI) indicating an identifier of an individual cell, a tracking area identifier (TAI) that manages a waiting area due to paging, random access setting information (transmission timing timer or the like), common radio resource setting information in the cell, neighboring cell information, uplink access restriction information and the like are notified.

The downlink reference signals are classified into a plurality of types according to their use. For example, the cell-specific reference signal (RS) is a pilot signal that is transmitted with a prescribed power for each cell and a downlink reference signal that is periodically repeated in the frequency domain and the time domain based on a prescribed rule. In the terminal device, reception quality of each cell is measured by receiving the cell-specific RS. The terminal device uses the cell-specific RS also as a signal for reference, which is transmitted simultaneously with the cell-specific RS, for demodulation of the physical downlink control channel or the physical downlink shared channel. As a sequence used in the cell-specific RS, a sequence capable of being identified is used for each cell.

The downlink reference signal is also used in estimation of propagation fluctuation of downlink. A downlink reference signal used in estimation of the propagation fluctuation is called a channel state information reference signal (CSI-RS). A downlink reference signal individually set to the terminal device is called a UE specific reference signals (URS), a demodulation reference signal (DMRS), or a dedicated RS (DRS), and is referenced for channel compensation processing when the enhanced physical downlink control channel or the physical downlink shared channel is demodulated.

The physical downlink control channel (PDCCH) is transmitted through several OFDM symbols (for example, 1 to 4 OFDM symbols) from a top of each sub-frame. The enhanced physical downlink control channel (EPDCCH) is the physical downlink control channel assigned to the OFDM symbol to which the physical downlink shared channel PDSCH is assigned. The PDCCH or EPDCCH is used for the purpose of notifying the terminal device of radio resource allocation information depending on scheduling of the base station apparatus or information indicating an amount of an increase and decrease adjustment of transmit power. In the following, in a case where it is described simply as physical downlink control channel (PDCCH), when it is not particularly clearly described, it means both physical channels of PDCCH and EPDCCH.

Before a layer 2 message and a layer 3 message (paging, handover command, or the like) which are downlink data or higher layer control information are transmitted and received, the terminal device needs to acquire radio resource allocation information which is called an uplink grant at the time of transmission and a downlink grant (downlink assignment) at the time of reception from the physical downlink control channel by monitoring the physical downlink control channel of the destination of its own device and receiving the physical downlink control channel of the destination of its own device. The physical downlink control channel may be constituted to be transmitted through an area of a resource block individually assigned (dedicated) to the terminal device from the base station apparatus in addition to being transmitted through the OFDM symbols.

The physical uplink control channel (PUCCH) is used for performing a reception acknowledgement (Hybrid Automatic repeat reQuest-acknowledgement (HARQ-ACK) or acknowledgement/negative acknowledgement (ACK/NACK)) for downlink data transmitted through the physical downlink shared channel or a request for channel state information (CSI) of downlink and a radio resource allocation request (radio resource request, scheduling request (SR)) of uplink.

The CSI includes a reception quality indicator (channel quality indicator (CQI)), a precoding matrix indicator (PMI), a Precoding Type Indicator (PTI), and a rank indicator (RI) and each is able to be used for designating (representing) a preferable modulation scheme and coding rate, a preferable precoding matrix, a preferable PMI type, and a preferable rank. Each Indicator may also be denoted by Indication. The CQIs and PMIs are classified into a widiband CQI and PMI assuming that all resource blocks within 1 cell are used and a sub-band CQI and PMI assuming that some contiguous resource blocks (sub-bands) within 1 cell are used. As the PMI, in addition to a normal type of PMI representing 1 preferable precoding matrix by 1 PMI, there exists a PMI having a type representing 1 preferable precoding matrix using two types of first PMI and second PMI.

The physical downlink shared channel (PDSCH) is used for notifying the terminal device of broadcast information (system information) not notified through paging or the physical broadcast information channel, in addition to downlink data, as the layer 3 message. The radio resource allocation information of physical downlink shared channel is indicated through the physical downlink control channel. The physical downlink shared channel is assigned to OFDM symbols to be transmitted in addition to the OFDM symbols through which the physical downlink control channel is transmitted. That is, the physical downlink shared channel and the physical downlink control channel are subjected to time division multiplexing within 1 sub-frame.

The physical uplink shared channel (PUSCH) is also able to transmit mainly uplink data and uplink control information and includes uplink control information such as CSI or ACK/NACK. In addition to the uplink data, the physical uplink shared channel may also be used for notifying the base station apparatus of the layer 2 message and the layer 3 message which are higher layer control information from the terminal device. Similar to downlink, radio resource allocation information of the physical uplink shared channel is indicated by the physical downlink control channel.

The uplink reference signal (referred to as uplink pilot signal, and uplink pilot channel) includes a demodulation reference signal (DMRS) used for demodulating the physical uplink control channel PUCCH and/or the physical uplink shared channel PUSCH by the base station apparatus and sounding reference signal (SRS) used for estimating mainly the channel state of uplink by the base station apparatus. In the sounding reference signal, there is a periodic sounding reference signal (Periodic SRS) which is periodically transmitted and an non-periodic sounding reference signal (Aperiodic SRS) which is transmitted each time when instruction is issued from the base station apparatus.

The physical random access channel (PRACH) is channel used for notifying (setting) of a preamble sequence and includes the guard time. The preamble sequence is constituted to notify the base station apparatus of information by a plurality of sequences. For example, in a case where 64 types of sequences are prepared, 6-bit information is able to be used for indicating the base station apparatuses. The physical random access channel is used as access means of accessing the base station apparatus of the terminal devices.

The terminal device uses the physical random access channel in order to request for the radio resource of uplink to SR at the time of non-setting of the physical uplink control channel and request for transmission timing adjustment information (referred also to as timing advance (TA)) command) needed for making the uplink transmission timing match a reception timing window of the base station apparatus to the base station apparatus. The base station apparatus is able to request starting of a random access procedure to the terminal device using the physical downlink control channel.

The layer 3 message is a message treated by a protocol of a control-plane (C-plane (CP)) exchanged in a radio resource control (RRC) layer of the terminal device and the base station apparatus and may be used synonymously to RRC signaling or a RRC message. In contrast to the control plane, a protocol that treats user data (uplink data and downlink data) is called a user-plane (U-plane (UP)). Here, a transport block which is transmit data in the physical layer includes a C-plane message and U-plane data in a higher layer. Detailed description of a physical channel other than the physical channel will be omitted.

A communicable range (communication area) of each frequency controlled by the base station apparatus is regarded as a cell. In this case, a communication area covered by the base station apparatus may also have different extents or different shapes for each frequency. The area to be covered may also be different for each frequency. A radio network forming a single communication system in which cells, in which types or sizes of cell radius of the base station apparatuses are different, are mixed in the areas of the same frequency and/or different frequencies is called a heterogeneous network.

The terminal device operates regarding inside of a cell as a communication area. When a terminal device is moved from a certain cell to a separate cell, the terminal device is moved to a separate suitable cell through a cell reselection procedure when not being in a radio-connection (not being in communication) or a handover procedure when being in a radio-connection (being in communication). The suitable cell is a cell which is determined, based on information designated by base station apparatus, that accessing by a general terminal device is not prohibited and indicates a cell that satisfies a prescribed condition in reception quality of downlink.

In the terminal device and the base station apparatus, a technology in which frequencies (component carriers, or frequency bandwidths) of a plurality of different frequency bands (frequency bands) are aggregated by carrier aggregation and treated as a single frequency (frequency bandwidth) may also be applied. As the component carriers, there are an uplink component carrier corresponding to uplink and a downlink component carrier corresponding to downlink. In the present specification, frequency and frequency bandwidth may be used synonymously.

For example, in a case where 5 component carriers of which frequency bandwidths are respectively 20 MHz are aggregated by carrier aggregation, the terminal device with capability capable of performing carrier aggregation transmits/receives by regarding the frequency bandwidths as a frequency bandwidth of 100 MHz. The component carriers to be aggregated may also be contiguous frequencies or frequencies all or some of which are non-contiguous. For example, in a case where usable frequency bands are 800 MHz band, 2 GHz band, and 3.5 GHz band, a certain component carrier may be 800 MHz band, another component carrier may be 2 GHz band, and still another component carrier may be 3.5 GHz band.

It is possible to aggregate a plurality of component carriers which are contiguous component carriers having the same frequency band and are non-contiguous component carriers. The frequency bandwidth of each component carrier may be a frequency bandwidth (for example, 5 MHz or 10 MHz) narrower than a receivable frequency bandwidth (for example, 20 MHz) of the terminal device and the frequency bandwidths to be aggregate may be respectively different from each other. Although the frequency bandwidth is preferably equal to any of frequency bandwidths of the conventional cell in consideration of backward compatibility, the frequency bandwidth may be different from the frequency band of the conventional cell.

The component carriers (carrier type) without having backward compatibility may also be aggregated. The number of uplink component carriers assigned (to be set and added) to the terminal device by the base station apparatus is preferably equal to or less than the number of downlink component carriers.

A cell constituted with an uplink component carrier for which setting of the uplink control channel for requesting radio resources and a downlink component carrier cell-specifically connected with the uplink component carrier is called a primary cell (PCell). A cell constituted with component carrier other than the primary cell is called a secondary cell (SCell). The terminal device performs reception of a paging message, detection of update of broadcast information, an initial access procedure, setting of security information and the like in the primary cell and on the other hand, may not also perform those operations in the secondary cell.

Although the primary cell is not a target of control of activation and deactivation (that is, always regarded as being activated), the secondary cell has states referred to as activation and deactivation and change of these states is explicitly designated by the base station apparatus, but the states are changed based on a timer set in the terminal device for each component carrier. The primary cell and the secondary cell are together called a serving cell.

The carrier aggregation is communication by a plurality of cells using a plurality of component carriers (frequency band) and is also called cell aggregation. The terminal device may also be radio-connected with the base station apparatus through a relay station device (or repeater) for each frequency. That is, the base station apparatus of the present embodiment may be replaced with the relay station device.

The base station apparatus manages a cell, which is an area in which the terminal device is communicable with the base station apparatus, for each frequency. A single base station apparatus may also manage a plurality of cells. The cells are classified into a plurality of types according to sizes (cell size) of areas communicable with the terminal devices. For example, the cells are classified into macro cells and small cells. Furthermore, the small cells are classified into femto cells, pico cells, and nano cells according to sizes of the areas. When the terminal device is able to communicate with a certain base station apparatus, a cell which is set to be used for communication with the terminal device, among the cells of the base station apparatus, is a serving cell and a cell which is not used in communication with the terminal device is called a neighboring cell.

In other words, in the carrier aggregation (also referred to as carrier aggregation), a plurality of serving cells which are set includes a single primary cell and one or more secondary cells.

The primary cell is a serving cell for which an initial connection establishment procedure has been performed, a serving cell initiating a connection reestablishment procedure, or a cell indicated as a primary cell in the handover procedure. The primary cell operates at primary frequency. A secondary cell may also be set when the connection is (re)constructed or thereafter. The secondary cell operates at secondary frequency. The connection may also be referred to as RRC connection. For the terminal device that supports CA, resources are aggregated in a single primary cell and one or more secondary cells.

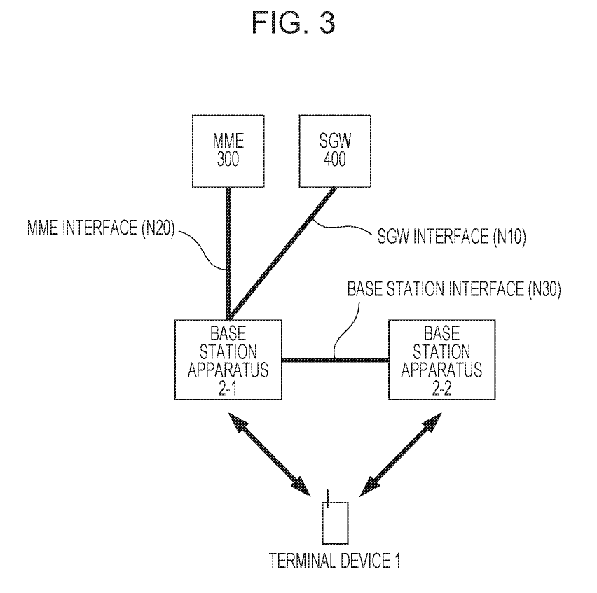

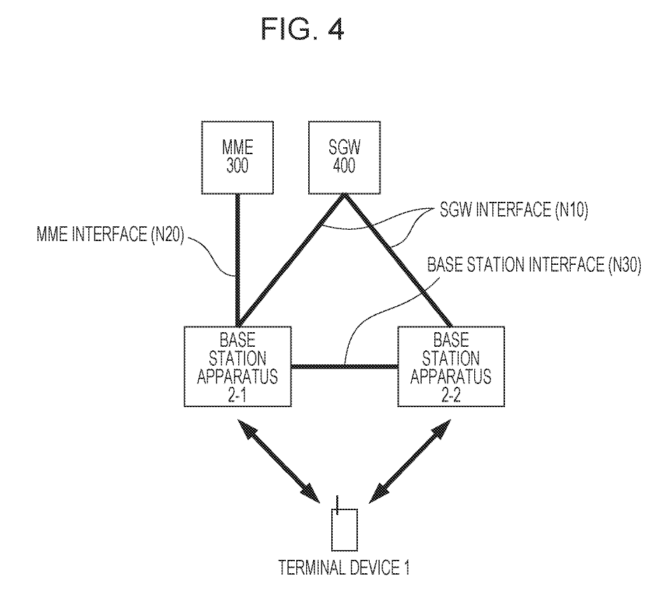

The basic structure (architecture) of the dual connectivity will be described with reference to FIG. 3 and FIG. 4. FIG. 3 and FIG. 4 illustrate that the terminal device 1 is simultaneously connected with a plurality of base station apparatuses 2 (indicated by base station apparatus 2-1 and the base station apparatus 2-2 in the figure). It is assumed that the base station apparatus 2-1 is a base station apparatus constituting the macro cell and a base station apparatus 2-2 is a base station apparatus constituting the small cell. As such, matters that the terminal device 1 is simultaneously connected with the plurality of base station apparatuses 2 using a plurality of cells belonging to a plurality of base station apparatuses 2 are referred to as dual connectivity. Cells belonging to each base station apparatus 2 may also be operated at the same frequency and be operated at a different frequency.

The carrier aggregation is different from the dual connectivity in that a plurality of cells are managed by a single base station apparatus 2 and the frequencies of respective cells are different. In other words, carrier aggregation is a technique in which a single terminal device 1 and a single base station apparatus 2 are connected through a plurality of cells having different frequencies, while dual connectivity is a technique in which a single terminal device 1 and a plurality of base station apparatuses 2 are connected through a plurality of cells having the same or different frequencies.

The terminal device 1 and the base station apparatus 2 are also able to apply the technique applied to the carrier aggregation to the dual connectivity. For example, the terminal device 1 and the base station apparatus 2 may also apply the technique such as assignment of the primary cell and the secondary cell or activation/deactivation to the cell connected by dual connectivity.

In FIG. 3 and FIG. 4, the base station apparatus 2-1 or the base station apparatus 2-2 is connected with an MME 300 and an SGW 400 by backbone lines. The MME 300 is a higher level control station device corresponding to a mobility management entity (MME) and serves to perform mobility management and authentication control (security control) of the terminal device 1 or set a path of user data to the base station apparatus 2. The SGW 400 is a higher level control station device corresponding to a serving gateway (S-GW) and serves to transfer user data according to a path of user data to the terminal device 1 which is set by the MME 300.

In FIG. 3 and FIG. 4, a connection path between the base station apparatus 2-1 or the base station apparatus 2-2 and the SGW 400 is called an SGW interface N10. A connection path between the base station apparatus 2-1 or the base station apparatus 2-2 and the MME 300 is called an MME interface N20. A connection path between the base station apparatus 2-1 and the base station apparatus 2-2 is called a base station interface N30. The SGW interface N10 is also called an S1-U interface in the EUTRA. The MME interface N20 is also called an S1-MME interface in the EUTRA. The base station interface N30 is also called an X2 interface in the EUTRA.

As the architecture for realizing dual connectivity, it is possible to adopt a configuration illustrated in FIG. 3. In FIG. 3, the base station apparatus 2-1 and the MME 300 are connected by the MME interface N20. The base station apparatus 2-1 and the SGW 400 are connected by the SGW interface N10. The base station apparatus 2-1 provides a communication path, which is for the MME 300 and/or SGW 400, to the base station apparatus 2-2 through the base station interface N30. In other words, the base station apparatus 2-2 is connected to the MME 300 and/or SGW 400 via the base station apparatus 2-1.

As a separate architecture for realizing dual connectivity, it is possible to adopt a configuration illustrated in FIG. 4. In FIG. 4, the base station apparatus 2-1 and the MME 300 are connected by the MME interface N20. The base station apparatus 2-1 and the SGW 400 are connected by the SGW interface N10. The base station apparatus 2-1 provides a communication path, which is for the MME 300, to the base station apparatus 2-2 through the base station interface N30. In other words, the base station apparatus 2-2 is connected to the MME 300 via the base station apparatus 2-1. The base station apparatus 2-2 is connected to the SGW 400 through the SGW interface N10.

The base station apparatus 2-2 and the MME 300 may also be configured to be directly connected by the MME interface N20.

When it is explained from a different point of view, dual connectivity is an operation in which a prescribed terminal device consumes radio resources provided from at least two different network points (master base station apparatus (Master eNB (MeNB))) and the secondary base station apparatus (Secondary eNB (SeNB)). In other words, in the dual connectivity, the terminal device performs an RRC connection in at least two network points. In dual connectivity, the terminal device may also be connected in an RRC connection (RRC_CONNECTED) state and may also be connected by non-ideal backhaul.

In dual connectivity, the base station apparatus which is connected to at least S1-MME and serves as a mobility anchor in the core network is called a master base station apparatus. The base station apparatus which does not provide additional radio resources to the terminal device in the master base station apparatus is called secondary base station apparatus. A group of the serving cells associated with the master base station apparatus may be called a master cell group (MCG) and a group of the serving cells associated with the secondary base station apparatus may be called a secondary cell group (SCG). The cell group may also be a serving cell group.

In dual connectivity, the primary cell belongs to the MCG. In the SCG, the secondary cell corresponds to the primary cell is called a primary secondary cell (pSCell). The pSCell may also be called a special cell or a special secondary cell (Special SCell). In the special SCell (base station apparatus constituting special SCell), some (for example, a function of transmitting and receiving PUCCH) of functions of the PCell (base station apparatus constituting PCell) may also be supported. In the pSCell, only some of functions of PCell may also be supported. For example, in the pSCell, a function of transmitting the PDCCH may also be supported. In the pSCell, a function of transmitting the PDCCH using search space different from the CSS or the USS may also be supported. For example, the search space different from the VSS is a search space determined based on values defined in the specification, search space determined based on the RNTI different from the C-RNTI, search space determined based on a value set by a higher layer different from the RNTI and the like. The pSCell may always be in a state of being activated. The pSCell is a cell which is able to receive the PUCCH.

In dual connectivity, date radio bearer (DRB) may also be individually assigned in the MeNB and the SeNB. On the other hand, signalling radio bearer (SRB) may also be assigned only to the MeNB. In dual connectivity, a duplex mode may be individually set in each of the MCG and the SCG or each of PCell and pSCell. In dual connectivity, the MCG and the SCG or the PCell and pSCell may not be synchronized, respectively. In dual connectivity, parameters for a plurality of timing adjustment (timing advanced group (TAG)) may also be set in each of the MCG and the SCG. That is, the terminal device is able to perform uplink transmission on different a plurality of timings within each CG.

In dual connectivity, the terminal device is able to transmit the UCI, which corresponds to a cell in the MCG, only to the MeNB (PCell) and transmit the UCI, which corresponds to a cell in the SCG, only to the SeNB (pSCell). For example, the UCI is an SR, an HARQ-ACK, and/or a CSI. Further, in the transmission of each UCI, a transmission method using the PUCCH and/or PUSCH is applied in each cell group.

Although all of the signals can be transmitted/received in the primary cell, there are signals that cannot be transmitted/received in the secondary cell. For example, the physical uplink control channel (PUCCH) is transmitted only in the primary cell. The physical random access channel (PRACH) is transmitted only in the primary cell as long as a plurality of timing advance groups (TAG) are not set between cells. The physical broadcast channel (PBCH) is transmitted only in the primary cell. The master information block (MIB) is transmitted only in the primary cell. Signals capable of being transmitted/received in the primary cell are transmitted/received in the primary secondary cell. For example, the PUCCH may also be transmitted in the primary secondary cell. The PRACH may also be transmitted in the primary secondary cell regardless of whether a plurality of TAGs are set. The PBCH and the MIB may also be transmitted in the primary secondary cell.

In the primary cell, a radio link failure (RLF) is detected. The secondary cell does not recognize that the RLF is detected even when a condition that the RLF is detected is prepared. In the primary secondary cell, when the condition is satisfied, the RLF is detected. In the primary secondary cell, in a case where the RLF is detected, a higher layer of the primary secondary cell notifies that the RLF is detected to a higher layer of the primary cell. In the primary cell, a semi-persistent scheduling (SPS) or a discontinuous transmission (DRX) may also be performed. In the secondary cell, the same DRX as the primary cell may also be performed. In the secondary cell, information/parameters related to setting of the MAC are basically shared with the primary cell/primary secondary cells of the same cell group. Some of the parameters (for example, sTAG-Id) may be set for each secondary cell. Some of the timers or counters may be applied only to the primary cell and/or primary secondary cell. The timer or counter applied only to the secondary cell may also be set.

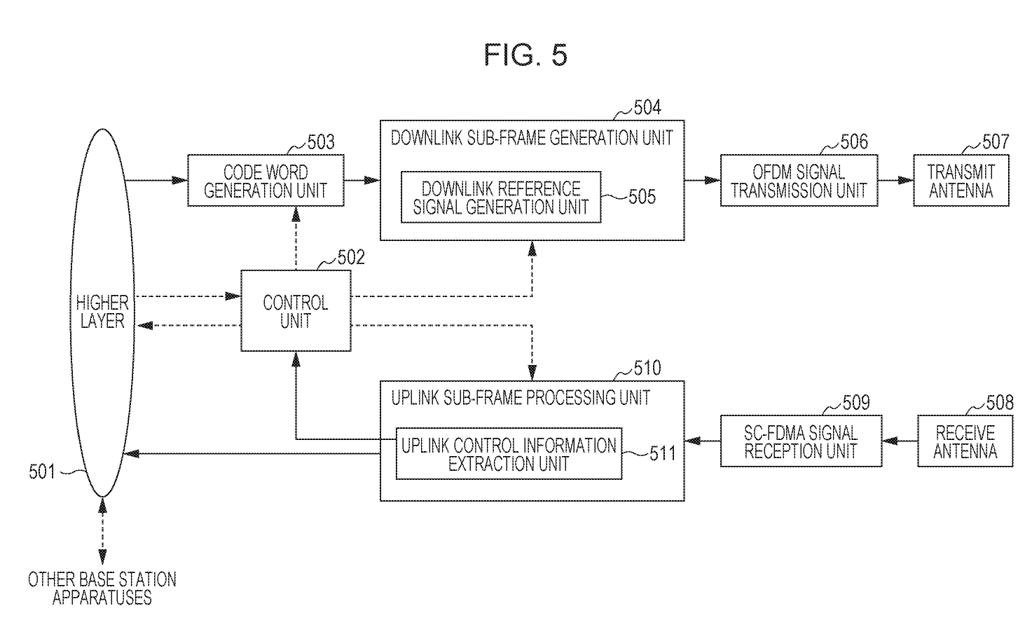

FIG. 5 is a schematic diagram illustrating an example of a configuration of blocks of the base station apparatus 2-1 and the base station apparatus 2-2 according to the present embodiment. The base station apparatus 2-1 and the base station apparatus 2-2 include a higher layer (higher layer control information notification unit) 501, a control unit (base station control unit) 502, a code word generation unit 503, a downlink sub-frame generation unit 504, an OFDM signal transmission unit (downlink transmission unit) 506, a transmit antenna (base station transmit antenna) 507, a receive antenna (base station receive antenna) 508, an SC-FDMA signal reception unit (CSI reception unit) 509, and an uplink sub-frame processing unit 510. The downlink sub-frame generation unit 504 includes a downlink reference signal generation unit 505. The uplink sub-frame processing unit 510 includes an uplink control information extraction unit (CSI acquisition unit) 511.

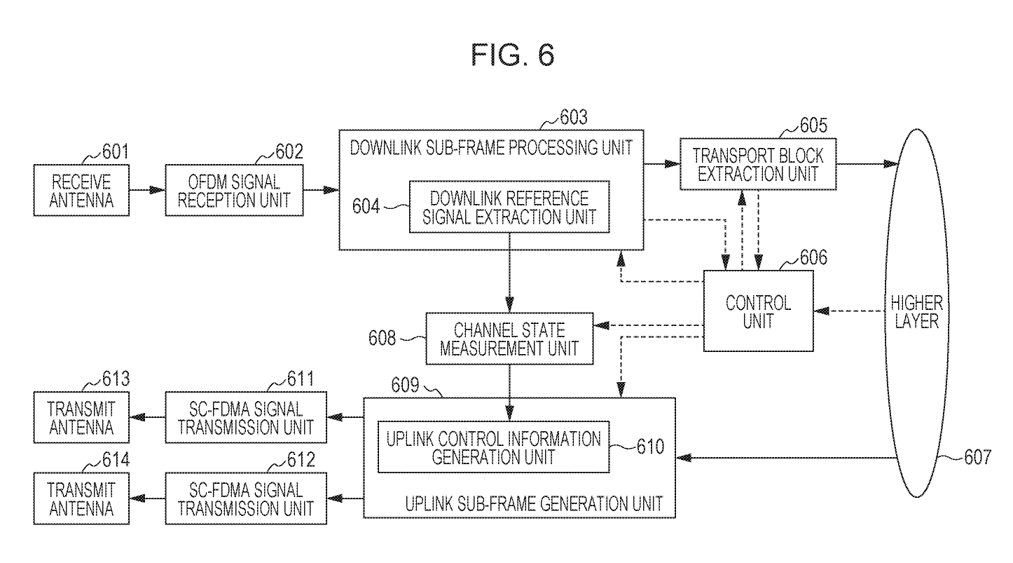

FIG. 6 is a schematic diagram illustrating an example of a configuration of blocks of the terminal device 1 according to the present embodiment. The terminal device 1 includes a receive antenna (terminal receive antenna) 601, an OFDM signal reception unit (downlink reception unit) 602, a downlink sub-frame processing unit 603, a transport block extraction unit (data extraction unit) 605, a control unit (terminal control unit) 606, a higher layer (higher layer control information acquisition unit) 607, a channel state measurement unit (CSI generation unit) 608, an uplink sub-frame generation unit 609, SC-FDMA signal transmission units (UCI transmission unit) 611 and 612, and transmit antennas (terminal transmit antenna) 613 and 614. The downlink sub-frame processing unit 603 includes a downlink reference signal extraction unit 604. The uplink sub-frame generation unit 609 includes an uplink control information generation unit (UCI generation unit) 610.

First, a flow of transmission/reception of downlink data will be described using FIG. 5 and FIG. 6. In the base station apparatus 2-1 or the base station apparatus 2-2, the control unit 502 allocates a modulation and coding scheme (MCS) indicating a modulation scheme and coding rate or the like in downlink and downlink resources indicating the RB used in data transmission, retains information used for controlling the HARQ (redundancy version, HARQ process number, new data indicator), and controls the code word generation unit 503 or the downlink sub-frame generation unit 504 based on the MCS and information. Downlink data sent from the higher layer 501 (also referred to as downlink transport block) is subjected to processing such as error correction coding and rate matching processing are conducted in the code word generation unit 503, under the control of the control unit 502, and the code word is generated. In a single sub-frame in a single cell, up to two code words are transmitted simultaneously.

In the downlink sub-frame generation unit 504, a downlink sub-frame is generated according to an instruction from the control unit 502. First, the code word generated in the code word generation unit 503 is converted into a modulation symbol sequence by modulation processing such as a phase shift keying (PSK) modulation and a quadrature amplitude modulation (QAM) modulation. The modulation symbol sequence is mapped to REs in a portion of the RB and the downlink sub-frame for each antenna port is generated by pre-coding processing.

In this case, the transmission data sequence sent from the higher layer 501 includes higher layer control information which is control information in the higher layer (for example, dedicated (individual) radio resource control (RRC) signaling). In the downlink reference signal generation unit 505, a downlink reference signal is generated. The downlink sub-frame generation unit 504 maps the downlink reference signal to the RE within the downlink sub-frame according to an instruction of the control unit 502. The downlink sub-frames generated by the downlink sub-frame generation unit 504 is modulated into OFDM signal in the OFDM signal transmission unit 506 and are transmitted through the transmit antenna 507.

Here, although a configuration having a single transmission unit 506 and a single OFDM signal transmit antenna 507 is illustrated, in a case where the downlink sub-frame is transmitted using a plurality of antennas ports, a configuration having a plurality of OFDM signal transmission units 506 and a plurality of transmit antennas 507 may also be adopted.

The downlink sub-frame generation unit 504 may have capability of generating the downlink control channel of a physical layer such as the PDCCH and EPDCCH to be mapped to the REs within downlink sub-frame. A plurality of base station apparatuses (base station apparatus 2-1 and the base station apparatus 2-2) respectively transmits individual downlink sub-frames.

In the terminal device 1, an OFDM signal is received in the OFDM signal reception unit 602 through the receive antenna 601 and an OFDM demodulation processing is conducted. The downlink sub-frame processing unit 603 first detects the downlink control channel of the physical layer such as a PDCCH and EPDCCH. More specifically, the downlink sub-frame processing unit 603 decodes the PDCCH and the EPDCCH as ones having been transmitted in a region where the PDCCH and the EPDCCH may be confirmed a cyclic redundancy check (CRC) bit that has been previously added (blind decoding). That is, the downlink sub-frame processing unit 603 monitors the PDCCH and EPDCCH. In a case where the CRC bit matches with an ID (cell-radio network temporary identifier (C-RNTI)), a terminal-specific identifier, such as a semi persistent scheduling-C-RNTI (SPS-C-RNTI), assigned to a single terminal, or Temporaly C-RNTI assigned in advance from the base station apparatus, the downlink sub-frame processing unit 603 recognizes that the PDCCH or EPDCCH is able to be detected and takes out the PDSCH by using the control information included in the detected PDCCH or EPDCCH. The control unit 606 allocates, based on control information, an MCS indicating a modulation scheme and coding rate or the like in downlink and downlink resources indicating the RB used in downlink data transmission, retains information used for controlling the HARQ, and controls the downlink sub-frame processing unit 603, the transport block extraction unit 605 or the like based on the MCS and information. More specifically, the control unit 606 controls the downlink sub-frame processing unit 603, the transport block extraction unit 605 or the like such that RE demapping processing and demodulation processing that correspond to RE mapping processing and modulation processing are performed in the downlink sub-frame generation unit 504. The PDSCH taken out from the received downlink sub-frame is sent to the transport block extraction unit 605. The downlink reference signal extraction unit 604 within the downlink sub-frame processing unit 603 takes out the downlink reference signal from the downlink sub-frame.

In the transport block extraction unit 605, rate matching processing, rate matching processing corresponding to error correction coding, and error correction decoding in the code word generation unit 503 are conducted, and the transport block is extracted and sent to the higher layer 607. The transport block includes higher layer control information and the higher layer 607 informs the physical layer parameters necessary for the control unit 606 based on the higher layer control information. A plurality of base station apparatuses 2 (base station apparatus 2-1 and base station apparatus 2-2) respectively transmit separate downlink sub-frames and the above-mentioned processing may be performed on the downlink sub-frame of each of a plurality of base station apparatuses 2, respectively, in order to receive the downlink sub-frames in the terminal device 1. In this case, the terminal device 1 may also recognize that a plurality of downlink sub-frames are transmitted from a plurality of base station apparatuses 2 and may not recognize the plurality of downlink sub-frames. In a case where the terminal device 1 does not recognize the plurality of downlink sub-frames, the terminal device 1 may simply recognize that a plurality of downlink sub-frames are transmitted in a plurality of cells. In the transport block extraction unit 605, it is determined whether the transport block is correctly detected or not and the determination result is sent to control unit 606.

Next, a flow of transmission and reception of uplink signals will be described. In the terminal device 1, under the instruction of the control unit 606, a downlink reference signal extracted by the downlink reference signal extraction unit 604 is sent to the channel state measurement unit 608, the channel state and/or interference are measured in the channel state measurement unit 608, and the CSI is calculated based on the measured channel state and/or interference.

The control unit 606 instructs the uplink control information generation unit 610 to perform generating of HARQ-ACK (DTX (untransmitted), ACK (successful detection) or NACK (detection failure)) and mapping of the HARQ-ACK to downlink sub-frame based on the determination result as to whether the transport block is correctly detected. The terminal device 1 performs the processing for the downlink sub-frame for each of a plurality of cells, respectively. In the uplink control information generation unit 610, the PUCCH including the calculated CSI and/or HARQ-ACK is generated.

In the uplink sub-frame generation unit 609, a PUSCH including uplink data sent from the higher layer 607 and a PUCCH generated in the uplink control information generation unit 610 are mapped to the RB within the uplink sub-frame and an uplink sub-frame is generated. Here, the uplink sub-frame including the PUCCH and PUCCH are generated for each connectivity group (also referred to as a serving cell group or cell group). Although details of the connectivity group will be described later, here, it is assumed that there are two connectivity groups respectively corresponding to a base station apparatus 2-1 and the base station apparatus 2-2. In one connectivity group, the uplink sub-frame (for example, uplink sub-frames to be transmitted to base station apparatus 2-1) is subjected to SC-FDMA modulation and an SC-FDMA signal is generated in the SC-FDMA signal transmission unit 611 and transmitted through the transmit antenna 613.

In the other one connectivity group, the uplink sub-frame (for example, uplink sub-frames to be transmitted to base station apparatus 2-2) is subjected to SC-FDMA modulation and an SC-FDMA signal is generated in the SC-FDMA signal transmission unit 612 and transmitted through the transmit antenna 614. Also, in two or more connectivity groups, the uplink sub-frames may also be transmitted simultaneously using a single sub-frame.

In each of the base station apparatus 2-1 and the base station apparatus 2-2, the uplink sub-frame in a single connectivity group is received. Specifically, in the SC-FDMA signal reception unit 509, the SC-FDMA signal is received through the receive antenna 508 and SC-FDMA demodulation processing is performed. In the uplink sub-frame processing unit 510, the RB to which the PUCCH is mapped is extracted according to an instruction from the control unit 502 and the CSI included in the PUCCH is extracted in the uplink control information extraction unit 511. The extracted CSI is sent to the control unit 502. The CSI is used to control downlink transmission parameters (MCS, downlink resource assignment, HARQ, and the like) by the control unit 502.

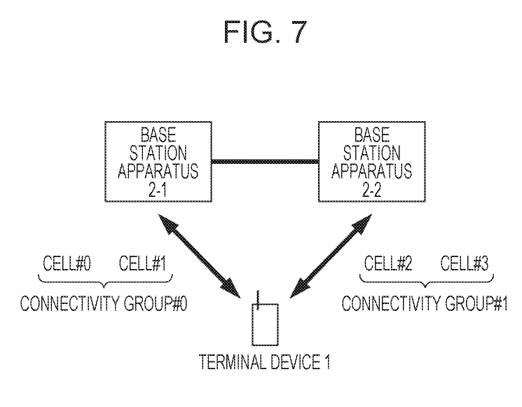

FIG. 7 illustrates an example of a connectivity group (cell group). The base station apparatus 2-1, the base station apparatus 2-2, and the terminal device 1 communicate in a plurality of serving cells (cell#0, cell#1, cell#2, and cell#3). The cell#0 is a primary cell and the cell#1, cell#2, and cell#3 which are other cells are secondary cells. The four cells are covered (provided) by the base station apparatus 2-1 and the base station apparatus 2-2 which are actually two different base station apparatuses. The cell#0 and cell#1 are covered by the base station apparatus 2-1 and the cell#2 and cell#3 are covered by the base station apparatus 2-2. Respective serving cells are classified into a plurality of groups and each group is referred to as a connectivity group.

Here, the serving cells across the low speed backhaul may be classified into different groups and a serving cell capable of using high-speed backhaul or a serving cell that does not need to use backhaul since being provided by the same device may be classified into the same group. A serving cell of the connectivity group to which the primary cell belongs may be called a master cell and a serving cell of another connectivity group may be called an assistant cell. One serving cell (for example, serving cell of which a serving cell index is smallest in connectivity group) in each connectivity group may be called a primary secondary cell or a PScell (also, described as pSCell) in short.

Each serving cell within the connectivity group has component carriers of the different carrier frequencies. On the other hand, serving cells of different connectivity groups may have the component carrier of which carrier frequencies are different from each other and the component carrier of which carrier frequencies are the same (the same carrier frequency is able to be set). For example, carrier frequencies of the downlink component carrier and the uplink component carrier included in the cell#1 are different from those of the cell#0.

On the other hand, carrier frequencies of the downlink component carrier and the uplink component carrier included in the cell#2 may be different from or may be the same as those of the cell#0. The SR is preferably transmitted to each connectivity group. A serving cell group including the primary cell may be called a master cell group and a serving cell group (including primary secondary cell) not including the primary cell may be called a secondary group.

The terminal device 1 and the base station apparatus 2 may use, for example, any of the following methods (1) to (5), as a method of grouping the serving cells. Also, the connectivity group may also be set using a method different from the methods (1) to (5).

(1) A value of a connectivity identifier is set in each serving cell and a serving cell in which the value of the connectivity identifier is set is regarded as a group. A value of a connectivity identifier of the primary cell may not be set and may be a prescribed value (for example, 0).

(2) A value of a connectivity identifier is set in each secondary cell and a secondary cell in which the same value of the connectivity identifier is set is regarded as a group. A secondary cell in which the same value of the connectivity identifier is not set is regarded as the same group as the primary cell.

(3) A value of a SCell timing advanced group (STAG) identifier is set in each secondary cell and a secondary cell in which the same STAG identifier value is set is regarded as a group. A secondary cell in which the STAG identifier is not set is regarded as the same group as the primary cell. This group is shared with a group for performing timing adjustment of uplink transmission for the downlink reception.

(4) Any one of values from 1 to 7 is set in each secondary cell as a secondary cell index (serving cell index). A primary cell is assumed as having a serving cell index of zero. The cells are grouped based on the serving cell indexes. For example, in a case where the secondary cell index is from 1 to 4, the secondary cell is regarded as being belonged to the same group as that of the primary cell and on the other hand, in a case where the secondary cell index is from 5 to 7, the secondary cell is regarded as being belonged to a group different from that of the primary cell.

(5) Any one of values from 1 to 7 is set in each secondary cell as a secondary cell index (serving cell index). A primary cell is assumed as having a serving cell index of zero. A serving cell index of a cell that belongs to each group is notified from the base station apparatus 2. Here, the connectivity identifiers, the STAG identifiers, and the secondary cell indexes may be set to the terminal device 1 by the base station apparatus 2-1 or the base station apparatus 2-2 using dedicated RRC signaling.

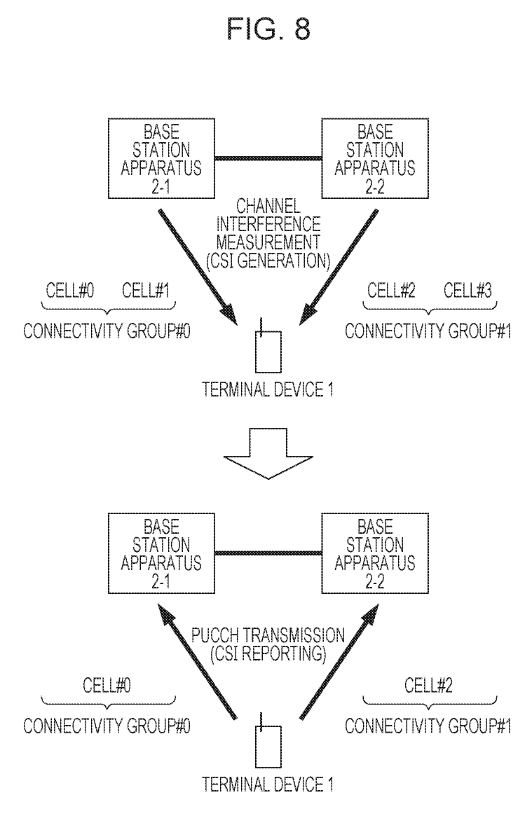

FIG. 8 illustrates an example of generation and reporting of CSI in the connectivity group of the terminal device 1. The base station apparatus 2-1 and/or the base station apparatus 2-2 set the parameters of the downlink reference signal to the terminal devices 1 in each serving cell and transmit a downlink reference signal in each serving cell to be provided. The terminal device 1 receives the downlink reference signal and performs channel measurements and/or interference measurement in each serving cell. The downlink reference signal referred to herein may include a CRS and a non-zero power CSI-RS, and a zero power CSI-RS. Preferably, the terminal device 1 performs channel measurement using a non-zero power CSI-RS and performs interference measurement using a zero power CSI-RS. Furthermore, based on the channel measurement result and the interference measurement result, the RI indicating a preferred rank, the PMI indicating a preferred precoding matrix, the CQI which is the largest index corresponding to a modulation scheme and coding rate satisfying required quality (for example, transport block error rate does not exceed 0.1) in a reference resource are calculated.

Next, the terminal device 1 reports the CSI. In this case, the CSI of each serving cell belonging to the connectivity group is reported using the uplink resource (PUCCH resource or PUSCH resource) in the cell of the connectivity group. Specifically, in a certain sub-frame, the CSI of cell#0 and the CSI of cell#1 are transmitted using PUCCH of the cell#0 which is a PScell of the connectivity group#0 and also the primary cell. In a certain sub-frame, the CSI of cell#0 and the CSI of cell#1 are transmitted using PUSCH of any one of cells belonging to the connectivity group#0. In a certain sub-frame, the CSI of cell#2 and the CSI of cell#3 are transmitted using PUCCH of the cell#2 which is a PScell of the connectivity group#1. In a certain sub-frame, the CSI of cell#2 and the CSI of cell#3 are transmitted using PUSCH of any one of cells belonging to the connectivity group#1. So to speak, each PScell is able to fulfill a portion of a function (for example, CSI transmission using PUCCH) of the primary cell in the conventional carrier aggregation. CSI reporting to the serving cell in each connectivity group performs the same behavior as CSI reporting to the serving cell in the carrier aggregation.

The PUCCH resources for periodic CSI of the serving cell belonging to a certain connectivity group are set in the PScells of the same connectivity group. The base station apparatus 1 transmits information for setting the PUCCH resources for the periodic CSI in the PScell to the terminal device 1. In a case where information for setting the PUCCH resources for the periodic CSI in the PScell are received, the terminal device 1 performs periodic CSI reporting using the PUCCH resources. The base station apparatus 1 does not transmit information for setting the PUCCH resources for the periodic CSI in cells other than the PScell to the terminal device 1. In a case where information for setting the PUCCH resources for the periodic CSI in cells other than the PScell are received, the terminal device 1 does not perform error handling and not perform periodic CSI reporting using the PUCCH resources.

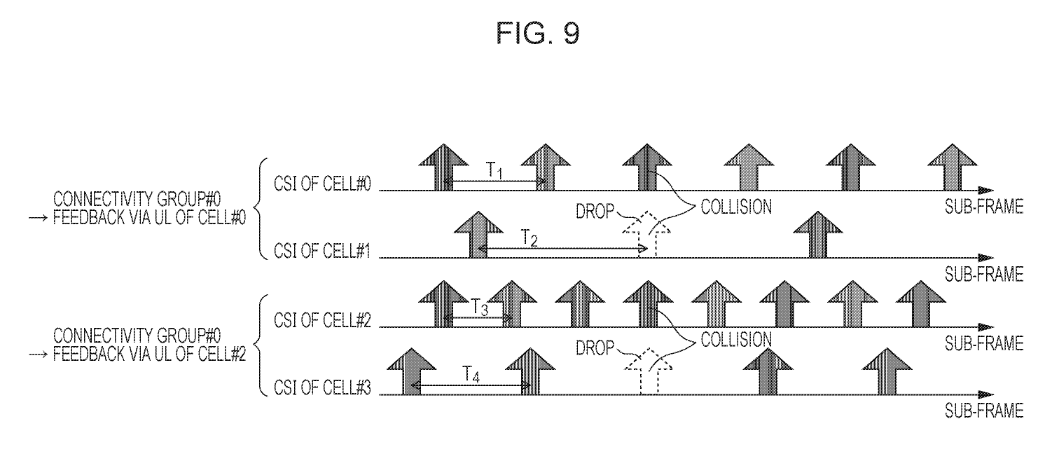

FIG. 9 illustrates an example of a periodic CSI reporting. The periodic CSI is periodically fed back from the terminal device 1 to the base station apparatus 2 in a sub-frame having a period set by dedicated RRC signaling. The periodic CSI is typically transmitted using the PUCCH. The periodic CSI parameters (period of sub-frame, offset from reference sub-frame to starting sub-frame, and reporting mode) may be set individually for each serving cell. The indexes of PUCCH resources for the periodic CSI may be set for each connectivity group. Here, the periods in the cells#0, #1, #2, and #3 are assumed to be set as T₁, T₂, T₃, and T₄, respectively. The terminal device 1 transmits the periodic CSI of the cell#0 in a sub-frame having a period of T₁ period in uplink and the periodic CSI of the cell#1 in a sub-frame having a period of T₂ period in uplink using the PUCCH resource of the cell#0 which is a PScell of the connectivity group#0 and also the primary cell. The terminal device 1 transmits the periodic CSI of the cell#2 in a sub-frame having a period of T₃ period in uplink and the periodic CSI of the cell#3 in a sub-frame having a period of T₄ period in uplink using the PUCCH resource of the cell#2 which is a PScell of the connectivity group#1. In a case where the periodic CSI reporting are collided (plurality of periodic CSI reporting occurs in a single sub-frame) between a plurality of servings within a single connectivity group, only single periodic CSI reporting is transmitted and other periodic CSI reporting will be dropped (not transmitted).

The terminal device 1 may use the methods indicated in the following as one of the determination method for transmitting periodic CSI reporting and/or HARQ-ACK using any of the uplink resources (PUCCH resource or PUSCH resource). That is, the terminal device 1 determines the uplink resource (PUCCH resource or PUSCH resource) that transmits the periodic CSI reportings and/or HARQ-ACK in accordance with one of the following (D1) to (D6) in each connectivity group.

(D1) In a case where more than one serving cells are set to the terminal device 1 and simultaneous transmission of PUSCH and PUCCH is not set, in sub-frame n, in a case where the uplink control information for the connectivity group includes only the periodic CSI and the PUSCH is not transmitted within the connectivity group, the uplink control information is transmitted by the PUCCH of the PScell in the connectivity group.

(D2) In a case where more than one serving cells are set to the terminal device 1 and simultaneous transmission of PUSCH and PUCCH is not set, in sub-frame n, in a case where the uplink control information for the connectivity group includes the periodic CSI and/or HARQ-ACK and the PUSCH is transmitted in the PScell within the connectivity group, the uplink control information is transmitted by the PUSCH of the PScell in the connectivity group.

(D3) In a case where more than one serving cells are set to the terminal device 1 and simultaneous transmission of PUSCH and PUCCH is not set, in sub-frame n, the uplink control information for the connectivity group includes the periodic CSI and/or HARQ-ACK, the PUSCH is not transmitted in the PScell within the connectivity group, and the PUSCH is transmitted in at least one secondary cells other than the PScells within the connectivity group, uplink control information is transmitted by the PUSCH of the secondary cell having the smallest cell index within the connectivity group.

(D4) In a case where more than one serving cells are set to the terminal device 1 and simultaneous transmission of PUSCH and PUCCH is set, in sub-frame n, in a case where the uplink control information for the connectivity group includes only the periodic CSI, the uplink control information is transmitted by the PUCCH of the PScell within the connectivity group.

(D5) In a case where more than one serving cells are set to the terminal device 1 and simultaneous transmission of PUSCH and PUCCH is set, in sub-frame n, in a case where the uplink control information for the connectivity group includes the periodic CSI and/or HARQ-ACK and the PUSCH is transmitted in the PScell within the connectivity group, the HARQ-ACK is transmitted by the PUCCH of the PScell in the connectivity group and the periodic CSI is transmitted by the PUSCH of the PScell in the connectivity group.

(D6) In a case where more than one serving cells are set to the terminal device 1 and simultaneous transmission of PUSCH and PUCCH is set, in sub-frame n, in a case where the uplink control information for the connectivity group includes the periodic CSI and/or HARQ-ACK, the PUSCH is not transmitted in the PScell within the connectivity group, and the PUSCH is transmitted in at least one different secondary cells within the connectivity group, the HARQ-ACK is transmitted by the PUCCH of the PScell within the connectivity group and the periodic CSI is transmitted by the PUSCH of the secondary cell having the smallest the secondary cell index within the connectivity group.

As such, in a communication system having the plurality of base station apparatuses 2 that respectively communicate with the terminal device 1 using one or more serving cell, the terminal device 1 sets a connectivity identifier for each serving cell in a higher layer control information acquisition unit and calculates periodic channel state information for each serving cell in a channel state information generation unit. In one sub-frame, in a case where the reports of periodic channel state information of the serving cell having the same connectivity identifier value collide, uplink control information is generated by dropping pieces of periodic channel state information other than one piece of periodic channel state information in an uplink control information generation unit, and an uplink sub-frame including the uplink control information is transmitted in the uplink control information. At least one of the base station apparatus 2-1 and the base station apparatus 2-2 set the values (for example, first value for serving cell of base station apparatus 2-1, second value for serving cell of base station apparatus 2-2, or the like) corresponding to each of the plurality of base station apparatuses as a connectivity identifier for each serving cell in a higher layer control information notification unit. Each of the base station apparatus 2-1 and the base station apparatus 2-1 receive an uplink sub-frame in an uplink control information reception unit and in a case where two or more periodic channel state information reporting for the serving cell having the connectivity identifier value which corresponds to a first base station apparatus collide in a single uplink sub-frame, uplink control information including a single piece of periodic channel state information of pieces of periodic channel state information that are colliding is extracted in an uplink control information extraction unit. Preferably, the CSI of the serving cell in each connectivity group is transmitted/received by an uplink sub-frame in the PScell of each connectivity group.

Here, both or only one of the base station apparatus 2-1 and the base station apparatus 2-2 may be provided with the function of higher layer control information notification unit. Matters that only one of the base station apparatus 2-1 and the base station apparatus 2-2 means that higher layer control information is transmitted from one of the base station apparatus 2-1 and the base station apparatus 2-2 in dual connectivity and does not mean that the base station apparatus 2-1 or the base station apparatus 2-2 does not have a configuration in which a higher layer control information notification unit itself is not included. In a case where the base station apparatus 2-1 and the base station apparatus 2-2 includes a backhaul transmit/receive mechanism and the base station apparatus 2-2 performs setting (including setting of connectivity group of the serving cells) associated to the serving cell provided by the base station apparatus 2-1, the base station apparatus 2-1 transmits information indicating the setting to the base station apparatus 2-2 through backhaul and the base station apparatus 2-2 performs setting (setting within base station apparatus 2-2 or signaling to terminal device 1) based on the information received through backhaul. In contrast, in a case where the base station apparatus 2-1 performs the setting associated to the serving cell provided by the base station apparatus 2-2, the base station apparatus 2-2 transmits information indicating the setting to the base station apparatus 2-1 through backhaul and the base station apparatus 2-1 performs setting (setting within base station apparatus 2-1 or signaling to terminal device 1) based on the information received through backhaul. Alternatively, the base station apparatus 2-2 may be responsible for some of functions of the higher layer control information notifying unit and the base station apparatus 2-1 may be responsible for the other functions. In this case, the base station apparatus 2-1 may be called a master base station apparatus and the base station apparatus 2-2 may be called an assist base station apparatus. The assist base station apparatus is able to provide settings (including connectivity group settings for the serving cells) associated to the serving cell provided by the assist base station apparatus to the terminal device 1. On the other hand, the master base station apparatus is able to provide settings (including connectivity group settings for the serving cells) associated to the serving cell provided by the master base station apparatus to the terminal device 1.

The terminal device 1 is able to recognize that terminal device 1 performs communications only with the base station apparatus 2-1. That is, a higher layer control information acquisition unit is able to acquire information notified from the base station apparatus 2-1 and the base station apparatus 2-2 by regarding the higher layer control information as one notified from the base station apparatus 2-1. Alternatively, the terminal device 1 may also recognize that the terminal device 1 performs communication with two base station apparatuses of the base station apparatus 2-1 and the base station apparatus 2-1. That is, the higher layer control information acquisition unit is able to acquire a piece of higher layer control information notified from the base station apparatus 2-1 and a piece of higher layer control information notified from the base station apparatus 2-2 and combine (merge) the pieces of higher layer control information.

With this, each base station apparatus 2 is able to receive a desired periodic CSI reporting directly from the terminal device 1 without passing through another base station apparatus 2. For that reason, even in a case where the base station apparatuses 2 are connected to each other through low speed backhaul, it is possible to perform scheduling using the periodic CSI reporting timely.

Next, aperiodic CSI reporting will be described. Aperiodic CSI reporting is instructed using a CSI request field in uplink grant sent in the PDCCH and EPDCCH and is transmitted using PUSCH. More specifically, the base station apparatus 2-1 or the base station apparatus 2-2 sets, first, n types (n is a natural number) of combinations (or combinations of CSI processes) of serving cells in the terminal device 1 using the dedicated RRC signaling. The CSI request field is able to represent n+2 types of states. Respective states indicate that the aperiodic CSI reporting is not fed back, the CSI reporting is fed back in the serving cell assigned by uplink grant (or in CSI process of serving cell assigned by uplink grant), and the CSI reporting is fed back in n types (n is a natural number) of combinations (or combinations of CSI processes) of preset serving cells. The base station apparatus 2-1 or the base station apparatus 2-2 sets the value of the CSI request field based on the desired CSI reporting and the terminal device 1 determines which one of the CSI reportings is to be performed based on the value of the CSI request field and performs the CSI report. The base station apparatus 2-1 or the base station apparatus 2-2 receives the desired CSI reporting.

In an example of an aperiodic CSI reporting during dual connectivity, n types (n is a natural number) of combinations (or combinations of CSI processes) of serving cells are set for each connectivity group. For example, the base station apparatus 2-1 or the base station apparatus 2-2 sets n types (n is a natural number) of combinations (or combinations of CSI processes within connectivity group#0) of serving cells within the connectivity group#0 and n types (n is a natural number) of combinations (or combinations of CSI processes within connectivity group#0) of serving cells within the connectivity group#1 in the terminal device 1. The base station apparatus 2-1 or the base station apparatus 2-2 sets the value of the CSI request field based on the desired CSI report. The terminal device 1 determines which one of the connectivity groups of the serving cell, to which PUSCH resources are assigned in the uplink grant requesting the aperiodic CSI report, belong to, determines which one of the CSI reportings is to be performed using n types (n is a natural number) of combinations (or combinations of CSI processes) of serving cells corresponding to the connectivity group, to which the serving cell, to which PUSCH resources are assigned in the uplink grant requesting the aperiodic CSI report, belong to, and performs the aperiodic CSI reporting using the PUSCH assigned in the uplink grant requesting the aperiodic CSI report. The base station apparatus 2-1 or the base station apparatus 2-2 receives the desired CSI report.

In another example of the aperiodic CSI reporting during dual connectivity, one of n types (n is a natural number) of combinations (or combinations of CSI processes) of serving cells is set. Each of n types (n is a natural number) of combinations (or combinations of CSI processes) of serving cells is limited to a combinations (or CSI process of serving cells belonging to connectivity group) of serving cells belonging to any of connectivity groups. The base station apparatus 2-1 or the base station apparatus 2-2 sets the value of the CSI request field based on the desired aperiodic CSI reporting and the terminal device 1 determines which one of the CSI reportings is to be performed based on the value of the CSI request field and performs the aperiodic CSI report. The base station apparatus 2-1 or the base station apparatus 2-2 receives the desired aperiodic CSI report.

With this, each base station apparatus 2 is able to receive the desired aperiodic CSI reporting directly from the terminal device 1 without passing through another base station apparatus 2. Each PUSCH includes only an aperiodic CSI reporting for a serving cell (or CSI process of serving cells belonging to a connectivity group) belonging to a single connectivity group and thus each base station apparatus 2 is able to receive the aperiodic CSI reporting, which is not dependent on other setting of the base station apparatus 2, directly from the terminal device 1. For that reason, even in a case where the base station apparatuses 2 are connected to each other through low speed backhaul, it is possible to perform scheduling using the aperiodic CSI reporting timely.

Next, description will be made on uplink power control of the terminal device 1 in dual connectivity. Here, the uplink power control includes power control in uplink transmission. The uplink transmission includes transmission of the uplink signal/uplink physical channel such as PUSCH, PUCCH, PRACH, SRS, and the like. In the following description, the MeNB may also collectively notify (set) parameters associated to both the MeNB and SeNB. The SeNB may also collectively notify (set) parameters associated with both the MeNB and SeNB. The MeNB and SeNB may also individually notify (set) parameters associated with each of the MeNB and SeNB.

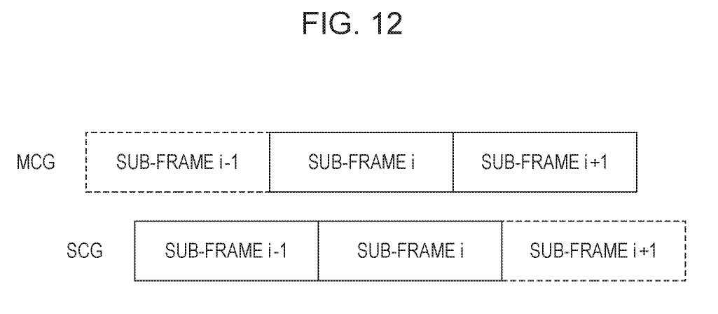

FIG. 12 is a diagram illustrating an example of an uplink transmission sub-frame in dual connectivity. In this example, the timing of uplink transmissions in MCG is different from the timing of the uplink transmission in the MCG. For example, a sub-frame i of MCG overlaps a sub-frame i−1 of SCG and a sub-frame i of SCG. The sub-frame i of SCG overlaps a sub-frame i of MCG and a sub-frame i+1 of the MCG. For that reason, transmit power control of uplink transmission in a certain cell group in dual connectivity preferably considers the transmit power of two sub-frames which overlaps in the other cell groups.

The terminal device 1 may perform uplink power control individually in the MCG including a primary cell and the SCG including a secondary cell. The uplink power control includes transmit power control for uplink transmission. The uplink power control includes transmit power control of the terminal device 1.

The terminal device 1 sets a maximum allowed output power P_{EMAX} of the terminal device 1 using signaling of higher layer/common signaling of higher layer (for example, system information block (SIB)). The maximum allowed output power may be called maximum allowed output power of higher layer. For example, P_{EMAX} which is the maximum allowed output power in a serving cell c is given by P-Max, which is set for the serving cell c. That is, P_{EMAX,c} is the same value as P-Max in the serving cell c.

In the terminal device 1, a power class P_{PowerClass} of the terminal device 1 is predefined for each frequency band. A power class is a maximum output power without considering predefined tolerance. For example, the power class is defined as 23 dBm. The maximum output power may be set separately for the MCG and SCG based on the predefined power class. The power class may be defined independently for the MCG and SCG.

The maximum output power which is set for each serving cell is set for the terminal device 1. The maximum output power P_{CMAX,c} which is set for the serving cell c is set for the terminal device 1. The P_{CMAX} is the sum of P_{CMAX,c}. The set maximum output power may be referred to as a maximum output power of the physical layer.

The P_{CMAX,c} is a value greater than or equal to P_{CMAX}_{_}_{L,c} and less than or equal to P_{CMAX}_{_}_{H,c}. For example, the terminal device 1 sets the P_{CMAX,c} within the range. The P_{CMAX}_{_}_{H,c} is the minimum value of the P_{EMAX,c} and P_{PowerClass}. The P_{CMAX}_{_}_{L,c} is the minimum value of a value based on P_{EMAX,c} and a value based on P_{Powerclass}. A value based on the P_{PowerClass} is a value obtained by subtracting a value based on maximum power reduction (MPR) from P_{PowerClass}. The MPR is a maximum power reduction for the maximum output power and is determined based on setting of a modulation scheme and a transmission bandwidth of the uplink channel and/or uplink signal to be transmitted. In each sub-frame, the MPR is evaluated for each slot and is given by the maximum value obtained through transmit over two slots. The MPR which is the maximum MPR over two slots within the sub-frame is applied for the entirety of sub-frame. That is, the MPR may be different for each sub-frame and thus, the P_{CMAX}_{_}_{L,c} may also be different for each sub-frame. As a result, the P_{CMAX,c} may also be different for each sub-frame.

The terminal device 1 is able to set or determine the P_{CMAX} for each of MeNB (MCG) and SeNB (SCG). That is, a sum of power allocation is able to be set or determined for each cell group. The sum of the set maximum output power for the MeNB is defined as P_{CMAX,MeNB} and the sum of the power allocation for MeNB is defined as P_{alloc}_{_}_{MeNB}. The sum of the set maximum output power for the SeNB is defined as P_{CMAX,SeNB} and the sum of the power allocation for SeNB is defined as P_{alloc}_{_}_{SeNB}. P_{CMAX,MeNB} and P_{alloc}_{_}_{MeNB} may be the same value. P_{CMAX,SeNB} and P_{alloc}_{_}_{SeNB} may be the same value. That is, the terminal device 1 performs transmit power control such that a total of the output power of the cell associated with MeNB (allocated power) is less than or equal to P_{CMAX,MeNB} or P_{alloc}_{_}_{MeNB} and a total of the output power of the cell associated with SeNB (allocated power) is less than or equal to P_{CMAX,SeNB} or P_{alloc}_{_}_{SeNB}. Specifically, the terminal device 1 scales transmit power of uplink transmission for each cell group so as not to exceed the value set for each cell group. Here, scaling, in each cell group, is to stop transmission or reduce transmit power for uplink transmission of which the priority is low based on a priority for uplink transmission to be simultaneously transmitted and set maximum output power for the cell group. In a case where transmit power control is performed individually for each uplink transmission, the method described in the present embodiment may be applied individually to each of the uplink transmission.

P_{CMAX,MeNB} and/or P_{CMAX,SeNB} is set based on a minimum guarantee power through signaling of a higher layer. In the following, details of the minimum guarantee power will be described.

The minimum guarantee power is individually set for each cell group. In a case where the minimum guarantee power is not set by higher layer signaling, the terminal device 1 may assume the minimum guarantee power as a predefined value (for example, 0). A set maximum output power for MeNB is defined as P_{McNB}. A set maximum output power for SeNB is defined as P_{SeNB}. For example, the P_{MeNB} and P_{SeNB} may be used as the minimum power which is guaranteed to hold the minimum communication quality for the uplink transmission to the MeNB and SeNB. The minimum guarantee power may also be called guarantee power, retention power, or the required power.

In a case where the sum of transmit power of uplink transmission for the MeNB and transmit power of uplink transmission for the SeNB exceeds P_{CMAX}, the guarantee power may be used to hold transmission quality or transmission of the signal or channel having a high priority based on predefined priorities. When the P_{MeNB} and P_{SeNB} are set as the minimum required power (in other words, guarantee power) used for communication and power allocation is calculated in each CG, the guarantee power may be used as a power value to be reserved for CGs other than the CG to be calculated.

The P_{MeNB} and P_{SeNB} are able to be defined as an absolute power value (for example, expressed in dBm unit). In the case of an absolute power value, the P_{MeNB} and P_{SeNB} are set. The total value of P_{MeNB} and P_{SeNB} is preferably equal to or less than P_{CMAX}, but is not limited to thereto. In a case where the total value of P_{MeNB} and P_{SeNB} is larger than P_{CMAX}, processing for reducing the total power to be equal to or less than the P_{CMAX} by scaling is further needed. For example, in the scaling, a single coefficient having a value less than 1 is multiplied to a total power value of MCG and the total power value of SCG.

The P_{MeNB} and P_{SeNB} may also be defined as a ratio (percentage, relative value) with respect to P_{CMAX}. For example, it may be expressed in units of dB with respect to a decibel value of P_{CMAX} and expressed as a percentage of a true value of P_{CMAX}. A ratio for the P_{MeNB} and a ratio for the P_{SeNB} are set and the P_{MeNB} and P_{SeNB} are determined based on the ratios. In a case of ratio notation, the sum of the ratios about the P_{SeNB} and P_{MeNB} is preferably 100% or less.

In other words, matters described above are as follows. P_{MeNB} and/or P_{SeNB} may be set in common or independently as a parameter for the uplink transmission through higher layer signaling. The P_{MeNB} indicates the minimum security power with respect to the sum of the transmit power allocated to each or all of the uplink transmission in the cell belonging to the MeNB. The P_{SeNB} indicates the minimum guarantee power with respect to the sum of the transmit power allocated to each or all of the uplink transmission in the cell belonging to the SeNB. The P_{MeNB} and P_{SeNB} are values greater than or equal to 0, respectively. The sum of P_{MeNB} and P_{SeNB} may be set so as not to exceed the PCMAx or a prescribed maximum transmit power. In the following description, a minimum security power is also referred to as security power or guarantee power.

The guarantee power may be set for each serving cell. The guarantee power may also be set for each cell group. The guarantee power may also be set for each base station apparatus (MeNB, SeNB). The guarantee power may also be set for each uplink signal. The guarantee power may also be set to the higher layer parameter. Only the P_{MeNB} is set in the RRC message and the P_{SeNB} may not also be set in the RRC message. In this case, a value (remaining power) obtained by subtracting the set P_{MeNB} from the P_{CMAX} may be set as the P_{SeNB}.

The guarantee power may also be set for each sub-frame regardless of the presence or absence of uplink transmission. The guarantee power may not also be applied for a sub-frame (for example, downlink sub-frame in TDD UL-DL setting) (terminal device recognizes that uplink transmission is not performed) for which uplink transmission is not expected. That is, the guarantee power for other CG may not be reserved in determining the transmit power for a certain CG. The guarantee power may also be applied for a sub-frame for periodic uplink transmission (for example, P-CSI, trigger type 0SRS, TTI bundling, SPS, RACH transmission by higher layer signaling, or the like) occurs. Information indicating whether the guarantee power is valid or invalid in all the sub-frames may be notified through the higher layer.

A sub-frame set to which guarantee power is applied may be notified as a higher layer parameter. The sub-frame set to which guarantee power is applied may also be set for each serving cell. The sub-frame set to which guarantee power is applied may also be set for each cell group. The sub-frame set to which guarantee power is applied may also be set for each uplink signal. The sub-frame set to which guarantee power is applied may also be set for each base station apparatus (MeNB, SeNB). The sub-frame set to which guarantee power is applied may also be common to the base station apparatuses (MeNB, SeNB). In this case, the MeNB and SeNB may also be synchronized. In a case where the MeNB and SeNB are asynchronous, the sub-frame sets to which guarantee power is applied may also be individually set.

In a case where the guarantee power is set for each of the MeNB (MCG, serving cell belonging to MCG) and SeNB (SCG, serving cell belonging to SCG), it may be determined whether the guarantee power is always to be set in all the sub-frames based on a frame structure type that is set in the MeNB (MCG, serving cell belonging to the MCG) and SeNB (SCG, serving cell belonging to SCG). For example, in a case where the frame structure types of the MeNB and SeNB differ, the guarantee power may be set in all the sub-frames. In this case, the MeNB and the SeNB may not be synchronized. In a case where the MeNB and the SeNB (radio frame and sub-frame of MeNB and SeNB) are synchronized, the guarantee power may not be taken into account in an FDD uplink sub-frame (sub-frame of the uplink cell) that overlaps a downlink sub-frame of TDD UL-DL setting (sub-frame of the uplink cell). That is, in this case, the maximum value of uplink power for uplink transmission may be P_{UE}_{_}_{MAX} or P_{UE}_{_}_{MAX,c} in the FDD uplink sub-frame.

In the following, details of a setting method (determination method) of P_{alloc,MeNB} and/or P_{alloc,SeNB} will be described.

An example of the determination of the P_{alloc,MeNB} and/or P_{alloc,SeNB} is performed in the following steps. In the first step, Pₚᵣₑ_{_}_{MeNB} and Pₚᵣₑ_{_}_{SeNB} are obtained in the MCG and the SCG, respectively. The Pₚᵣₑ_{_}_{MeNB} and Pₚᵣₑ_{_}_{seNB} are given by the minimum value of total power required for actual uplink transmission and guarantee power set to each cell group (that is, P_{MeNB} and P_{SeNB}) in each cell group. In the second step, residual power is allocated (added) to the Pₚᵣₑ_{_}_{MeNB} and Pₚᵣₑ_{_}_{SeNB} based on a prescribed method. The residual power is power obtained by subtracting the Pₚᵣₑ_{_}_{MeNB} and Pₚᵣₑ_{_}_{SeNB} from the P_{CMAX}. Some of or all the residual power are available. Powers determined based on the steps are used as the P_{alloc,MeNB} and P_{alloc,SeNB}.

An example of a power required for actual uplink transmission is determined based on actual allocation of uplink transmission and transmit power control for the uplink transmission. For example, in a case where the uplink transmission is PUSCH, the power is determined based on at least the number of RBs to which at least PUSCH is assigned, estimates of downlink path loss calculated by the terminal device 1, a value being referenced to a transmit power control command, and the parameters set by higher layer signaling. In a case where the uplink transmission is PUCCH, the power is determined based on at least a value which depends on a PUCCH, a value referenced to the transmit power control command, and estimates of downlink path loss calculated by the terminal device 1. In a case where the uplink transmission is the SRS, the power is determined based on at least the number of RBs for transmitting the SRS and a state adjusted for power control in the current PUSCH.

An example of a power required for the actual uplink transmission is the minimum value between power which is determined based on actual allocation of uplink transmission and transmit power control for the uplink transmission and the set maximum output power (that is, P_{CMAX,c}) in the cell to which the uplink transmission is assigned. Specifically, power required in a certain cell group (power required for actual uplink transmission) is given by Σ(min(P_{CMAX,j}, P_{PUCCH}+P_{PUSCH,j}). However, j indicates a serving cell associated with the cell group. The serving cell is a PCell or pSCell and in a case where there is no PUCCH transmission in the serving cell, PPJcC_{H} is assumed as 0. In a case where the serving cell is a SCell (that is, in a case where the serving cell is not a PCell or pSCell), P_{PUCCH} is assumed as 0. In a case where there is no PUSCH transmission in the serving cell, P_{PUSCH,j} is assumed as 0. A method for calculating the required power may use a method described in steps (t1) to (t9) which will be described later.

An example of determination of P_{alloc,MeNB} and/or P_{alloc,SeNB} is performed in the following steps. In the first step, Pₚᵣₑ_{_}_{MeNB} and Pₚᵣₑ_{_}_{SeNB} are obtained in the MCG and the SCG, respectively. The Pₚᵣₑ_{_}_{MeNB} and Pₚᵣₑ_{_}_{SeNB} are given by guarantee power set to each cell group (that is, P_{MeNB} and P_{SeNB}) in each cell group. In the second step, residual power is allocated (added) to the Pₚᵣₑ_{_}_{MeNB} and Pₚᵣₑ_{_}_{SeNB} based on a prescribed method. For example, the residual power is allocated by regarding a priority of a cell group transmitted first as high. For example, the residual power is allocated to the cell group transmitted first without considering a cell group likely to be transmitted later. The residual power is a power obtained by subtracting the Pₚᵣₑ_{_}_{MeNB} and Pₚᵣₑ_{_}_{SeNB} from the P_{CMAX}. Some or all of the residual power are all available. Power determined based on the steps are used as P_{alloc,MeNB} and P_{alloc,SeNB}.

Residual power may be allocated for the uplink channel and/or uplink signal that do not satisfy the P_{MeNB} or P_{ScNB}. Allocation of the residual power is performed based on a priority for a type of uplink transmission. The type of uplink transmission is a type of the uplink channel, uplink signal, and/or UCI. The priority is given beyond the cell group. The priority may also be defined in advance or may also be set by higher layer signaling.

An example of a case where a priority is defined in advance is based on a cell group and an uplink channel. For example, priorities for types of uplink transmission are defined by PUCCH in the MCG, PUCCH in the SCG, PUSCH including the UCI in the MCG. PUSCH including the UCI in the SCG, PUSCH not including the UCI in the MCG, PUSCH not including the UCI in the SCG in this order.

An example of a case where a priority is defined in advance is based on a type of a cell group, uplink channel, and/or UCI. For example, priorities for types of uplink transmission are defined by PUCCH or PUSCH including UCI including at least an HARQ-ACK and/or SR in the MCG, PUCCH or PUSCH including the UCI including at least an HARQ-ACK and/or SR in the SCG, PUCCH or PUSCH including the UCI including only the CSI in the MCG, PUCCH or PUSCH including the UCI including only the CSI in the SCG, PUSCH not including the UCI in the MCG, and PUSCH not including the UCI in the SCG in this order.

In an example of a case where the priority is set by higher layer signaling, the priority is set for the type of the cell group, the uplink channel and/or the UCI. For example, the priorities for the type of uplink transmission are set to PUCCH in the MCG, PUCCH in the SCG, PUSCH including the UCI in the MCG, PUSCH including the UCI in the SCG, PUSCH not including the UCI in MCG, and PUSCH not including the UCI in the SCG, respectively.

In an example of allocation of residual power based on the priority, the residual power is allocated to a cell group that includes the type of uplink transmission having the highest priority among respective cell groups. Remained power after allocation to the cell group that includes the type of uplink transmission having the highest priority is assigned further to another other cell group. Specific operations of the terminal device 1 are as follows.

In an example of allocation of residual power based on the priority, the residual power is allocated to a cell group of which the sum of parameters (points) is high based on the priority.

In an example of allocation of residual power based on the priority, the residual power is allocated to each cell group according to a ratio determined based on the sum of the parameter (points) based on the priority. For example, when the sum of the parameters (points) are respectively 15 and 5 in the MCG and SCG based on the priority, respectively, 75% of the residual power is allocated to the MCG and 25% of the residual power is allocated to the SCG. Parameters based on the priority may be determined further based on the number of resource blocks assigned to uplink transmission.

In an example of allocation of residual power based on the priority, the residual power is allocated for the types of uplink transmission having high priorities in order. The allocation of the residual power is performed beyond the cell group according to the priorities for the types of the uplink transmission. Specifically, the residual power may be allocated to satisfy the required power for the types of the uplink transmission having high priorities from the types of uplink transmission in order. Furthermore, the allocation of residual power is performed on the assumption that the Pₚᵣₑ_{_}_{MeNB} and Pₚᵣₑ_{_}_{SeNB} are allocated to the types of the uplink transmission having high priorities in each cell group. Based on the assumption, the residual power is allocated to the types of the uplink transmission having high priorities in order for the types of uplink transmission for which the required power is not satisfied.

In an example of allocation of residual power based on the priority, the residual power is allocated for the types of uplink transmission having high priorities in order. The allocation of the residual power is performed beyond the cell group according to the priorities for the types of the uplink transmission. Specifically, the residual power may be allocated to satisfy the required power for the types of the uplink transmission having high priorities from the types of uplink transmission in order. Furthermore, the allocation of residual power is performed on the assumption that the Pₚᵣₑ_{_}_{MeNB} and Pₚᵣₑ_{_}_{SeNB} are allocated to the types of the uplink transmission having low priorities in each cell group. Based on the assumption, the residual power is allocated to the types of the uplink transmission having high priorities in order for the types of uplink transmission for which the required power is not satisfied.

Another example of allocation of residual power based on the priority is as follows. A terminal device communicating with a base station apparatus using a first cell group and a second cell group includes a transmission unit that transmits the channel and/or the signal in a certain sub-frame based on the maximum output power of the first cell group. In a case where information on the uplink transmission is recognized in the second cell group, the residual power is allocated based on the priorities for the types of uplink transmission. The residual power is given by subtracting power determined based on the uplink transmission in the first cell group and power determined based on the uplink transmission in the second cell group from the sum of the maximum output power of the terminal device. The maximum output power is the sum of the power determined based on the uplink transmission in the first cell group and power allocated to the first cell group among the residual power.

The residual power is allocated to cell groups having the types of high priority uplink transmission in order.

Furthermore, the residual power is allocated by assuming the followings. Power determined based on the uplink transmission in the first cell group is allocated to the type of high priority uplink transmission within the first cell group. Power determined based on the uplink transmission in the second cell group is allocated to the type of high priority uplink transmission within the second cell group.

The residual power is allocated by assuming the followings. Power determined based on the uplink transmission in the first cell group is allocated to the type of low priority uplink transmission within the first cell group. Power determined based on the uplink transmission in the second cell group is allocated to the type of low priority uplink transmission within the second cell group.

The residual power is allocated based on the sum of the parameters determined based on the priorities for the types of uplink transmission in each cell group.

An example of a specific method of allocation of guarantee power and residual power (remaining power) between cell groups (CG) is as follows. In the power allocation between the CGs, allocation of guarantee power is performed in a first step and allocation of the residual power is performed in a second step. Power allocated in the first step is Pₚᵣₑ_{_}_{MeNB} and Pₚᵣₑ_{_}_{SeNB}. The sum of power allocated in the first step and power allocated in the second is P_{alloc}_{_}_{MeNB} and P_{alloc}_{_}_{SeNB}. The guarantee power is called first reserve power, or power allocated in the first step, or also called a first allocation power. The residual power is called second reserve power, or power allocated in the second step, or also called second allocation power.

An example of allocation of guarantee power follows the following rules.

(G1) For a certain CG (first CG) (in determining power to be allocated to a certain CG (first CG)), if a terminal device recognizes that uplink transmission is not performed in another CG (second CG) in a sub-frame which overlaps a sub-frame of the CG (first CG), at that time, the terminal device does not reserve (not allocate) guarantee power for allocation power of another CG (second CG).

(G2) Otherwise, the terminal device reserves (allocates) guarantee power for allocation power of another CG (second CG).

An example of allocation of residual power follows the following rules.

(R1) For a certain CG (first CG) (in determining power to be allocated to a certain CG (first CG)), if a terminal device recognizes that uplink transmission of which the priority is higher than uplink transmission in the CG (first CG) is performed in another CG (second CG) in a sub-frame which overlaps a sub-frame of the CG (first CG), at that time, the terminal device reserves the residual power for allocation power of another CG (second CG).

(R2) Otherwise, the terminal device allocates the residual power to the CG (first CG) and does not reserve the residual power for allocation power of another CG (second CG).

An example of allocation of guarantee power follows the following rules.

(G1) In a case where for a certain CG (first CG) (in determining power to be allocated to a certain CG (first CG)), if a terminal device does not recognize information on uplink transmission in another CG (second CG) in a sub-frame which overlaps a sub-frame of the CG (first CG), the terminal device performs the following operations. The terminal device allocates required power (Pₚᵣₑ_{_}_{MeNB} or Pₚᵣₑ_{_}_{SeNB}) for the allocation power of the CG (first CG) based on information on uplink transmissions in the CG (first CG). The terminal device allocates guarantee power (P_{MeNB} or P_{SeNB}) for the allocation power of another CG (second CG).

(G2) Otherwise, the terminal device performs the following operations. The terminal device allocates required power (Pₚᵣₑ_{_}_{MeNB} or Pₚᵣₑ_{_}_{SeNB}) for the allocation power of the CG (first CG) based on information on uplink transmissions in the CG (first CG). The terminal device allocates required power (Pₚᵣₑ_{_}_{MeNB} or Pₚᵣₑ_{_}_{SeNB}) for the allocation power of another CG (second CG) based on information on uplink transmissions in another CG (second CG).

An example of allocation of residual power follows the following rules.

(R1) In a case where for a certain CG (first CG) (in determining power to be allocated to a certain CG (first CG)), if a terminal device does not recognize information on uplink transmission in another CG (second CG) in a sub-frame which overlaps a sub-frame of the CG (first CG), the terminal device performs the following operations. The terminal device allocates the residual power for allocation power of the CG (first CG).

(R2) Otherwise, the terminal device allocates the residual power for the allocation power of the CG (first CG) and the allocation power of another CG (second CG) based on a prescribed method. As a specific method, a method described in the present embodiment may be used.

An example of definition (calculation method) of the residual power is as follows. In this example, the terminal device 1 recognizes allocation of uplink transmission to the sub-frame which overlaps in the other cell groups.

In a sub-frame i illustrated in FIG. 12, the residual power calculated in a case where allocation power (P_{alloc}_{_}_{MeNB}) for MCG is computed is given by subtracting the power (Pₚᵣₑ_{_}_{MeNB}) allocated in the first step in a sub-frame i of the MCG and power for a sub-frame, which overlaps the sub-frame i of the MCG, of the SCG from P_{CMAX}. In FIG. 12, the overlapping sub-frames of the SCG are a sub-frame i−1 and a sub-frame i of the SCG. Power for the sub-frame of the SCG is the maximum value between transmit power of actual uplink transmission in the sub-frame i−1 of the SCG and power (Pₚᵣₑ_{_}_{SeNB}) allocated in the first step in the sub-frame i of SCG.

In the sub-frame i illustrated in FIG. 12, the residual power calculated in a case where allocation power (P_{alloc}_{_}_{SeNB}) for SCG is computed is given by subtracting the power (Pₚᵣₑ_{_}_{SeNB}) allocated in the first step in a sub-frame i of the SCG and power for a sub-frame of the MCG, which overlaps the sub-frame i of the SCG, of the SCG from P_{CMAX}. In FIG. 12, the overlapping sub-frames of the MCG are a sub-frame i and a sub-frame i+1 of the MCG. Power for the sub-frame of the MCG is the maximum value between transmit power of actual uplink transmission in the sub-frame i of the MCG and power (Pₚᵣₑ_{_}_{MeNB}) allocated in the first step in the sub-frame i+1 of the MCG.

An example of definition (calculation method) of the residual power is as follows. In this example, the terminal device 1 does not recognize allocation of uplink transmission to the sub-frame which overlaps in the other cell groups.

In a sub-frame i illustrated in FIG. 12, the residual power calculated in a case where allocation power (P_{alloc}_{_}_{MeNB}) for MCG is computed is given by subtracting the power (Pₚᵣₑ_{_}_{MeNB}) allocated in the first step in a sub-frame i of the MCG and power for a sub-frame, which overlaps the sub-frame i of the MCG, of the SCG from P_{CMAX}. In FIG. 12, the overlapping sub-frames of the SCG are a sub-frame i−1 and a sub-frame i of the SCG. Power for the sub-frame of the SCG is the maximum value between transmit power of actual uplink transmission in the sub-frame i−1 of the SCG and the guarantee power (P_{SeNB}) in the sub-frame i of SCG.

In a sub-frame i illustrated in FIG. 12, the residual power calculated in a case where allocation power (P_{alloc}_{_}_{SeNB}) for the SCG is computed is given by subtracting the power (Pₚᵣₑ_{_}_{SeNB}) allocated in the first step in a sub-frame i of the SCG and power for a sub-frame, which overlaps the sub-frame i of the SCG, of the MCG from P_{CMAX}. In FIG. 12, the overlapping sub-frames of the MCG are a sub-frame i and a sub-frame i+1 of the MCG. Power for the sub-frame of the MCG is the maximum value between transmit power of actual uplink transmission in the sub-frame i of the MCG and the guarantee power (P_{MeNB}) in the sub-frame i+1 of the MCG.

Another example of definition (calculation) of residual power based on the priority is as follows. A terminal device communicating with a base station apparatus using a first cell group and a second cell group includes a transmission unit that transmits the channel and/or the signal in a certain sub-frame based on the maximum output power of the first cell group. In a case where information on the uplink transmission is recognized in the second cell group in a sub-frame which is at the rear side and overlaps the certain sub-frame, the maximum output power of the first cell group is the sum of power determined based on the uplink transmission in the first cell group in the certain sub-frame and power allocated to the first cell group among the residual power. The residual power is given by subtracting power determined based on the uplink transmission in the first cell group in the certain sub-frame and power for the second cell group from the sum of the maximum output power of the terminal device. The power for the second cell group is the maximum value between output power of the second cell group in a sub-frame which is at the front side and overlaps the certain sub-frame and the power determined based on uplink transmission of the second cell group in a sub-frame which is at the rear side and overlaps the certain sub-frame.

Another example of definition (calculation) of residual power is as follows. A terminal device communicating with a base station apparatus using a first cell group and a second cell group includes a transmission unit that transmits the channel and/or the signal in a certain sub-frame based on the maximum output power of the first cell group.

In a case where information on the uplink transmission is not recognized in the second cell group in a sub-frame which is at the rear side and overlaps the certain sub-frame, the maximum output power of the first cell group is the sum of power determined based on the uplink transmission in the first cell group in the certain sub-frame and power allocated to the first cell group among the residual power. The residual power is given by subtracting power determined based on the uplink transmission in the first cell group in the certain sub-frame and power for the second cell group from the sum of the maximum output power of the terminal device. The power for the second cell group is the maximum value between output power of the second cell group in a sub-frame which is at the front side and overlaps the certain sub-frame and the guarantee power of the second cell group in a sub-frame which is at the rear side and overlaps the certain sub-frame.

Another example of definition (calculation) of residual power is as follows. A terminal device communicating with a base station apparatus using a first cell group and a second cell group includes a transmission unit that transmits the channel and/or the signal in a certain sub-frame based on the maximum output power of the first cell group. In a case where information on the uplink transmission is not recognized in the second cell group in a sub-frame which is at the rear side and overlaps the certain sub-frame, the maximum output power of the first cell group is given by subtracting power for the second cell group from the sum of maximum output power of the terminal device. The power for the second cell group is the maximum value between output power of the second cell group in a sub-frame which is at the front side and overlaps the certain sub-frame and the guarantee power of the second cell group in a sub-frame which is at the rear side and overlaps the certain sub-frame.

In the following, another method of allocation of the guarantee power and residual power will be described.

First, as a step (s1), a power value of the MCG and a power value of the SCG are initialized to calculate surplus power (unallocated surplus power). Surplus guarantee power (unallocated guarantee power) is initialized. More specifically, it is set as P_{MCG}=0, P_{SCG}=0, P_{Remaining}=P_{CMAX}−P_{MeNB}−P_{SeNB}. It is set as P_{MeNB,Remaining}=P_{MeNB}, P_{SeNB,Remaining}=P_{SeNB}. Here, P_{MCG} and P_{SCG} are the power value of the MCG and the power value of the SCG, respectively and P_{Remaining} is a surplus power value. P_{CMAX}, P_{MeNB} and P_{SeNB} are parameters described above. P_{MeNB,Remaining} and P_{SeNB,Remaining} are the surplus guarantee power value of the MCG and the surplus guarantee power value of the SCG, respectively. Here, each power value is a linear value.

Next, surplus power and surplus guarantee power are sequentially allocated to each CG for PUCCH in the MCG, PUCCH in the SCG, PUSCH including UCI in the MCG, PUSCH not including the UCI in the MCG, PUSCH not including the UCI in the SCG in order. In this case, in a case where there is surplus guarantee power, the surplus guarantee power is allocated first and the surplus guarantee power is allocated after the surplus guarantee power is used up. An amount of power to be sequentially allocated to each CG is basically a power value required for each channel (power value based on transmit power control (TPC) command, resource assignment, or the like). However, in a case where surplus power or surplus guarantee power does not satisfy a required power value, all the surplus power or surplus guarantee power are allocated. When power is allocated to the CG, surplus power or surplus guarantee power is reduced by an amount of allocated power. Allocating surplus power or surplus guarantee power having a value of 0 has the same meaning as surplus power or surplus guarantee power is not allocated. In the following, (s2) to (s8) will be described as more specific power value calculation steps for each CG.

As step (s2), the following operation is performed. If there is PUCCH transmission in the MCG (or, if terminal device 1 recognizes that there is PUCCH transmission in the MCG), the operation of P_{MCG}=P_{MCG}+δ₁+δ₂, P_{MeNB,Remaining}=P_{MeNB,Remaining}−δ₁, P_{Remaining}=P_{Remaining}−δ₂ is performed. Here, δ₁=min (P_{PUCCH,MCG}, P_{MeNB,Remaining}) and δ₂=min (P_{PUCCH,MCG}−δ₁, P_{Remaining}). That is, a power value required for the PUCCH transmission is allocated from surplus guarantee power of the MCG to the MCG. In this case, in a case where the surplus guarantee power of the MCG is insufficient for the power required for PUCCH transmission, an insufficient amount of power is allocated to the MCG using surplus power after all surplus guarantee power is allocated to the MCG. Here, in a case where the surplus power is insufficient to the insufficient amount of power, all surplus power is allocated to the MCG. An amount of the power value allocated from the surplus guarantee power or surplus power is added to the power value of MCG. The power value allocated to the MCG is subtracted from the surplus guarantee power or surplus power. The P_{PUCCH,MCG} is a power value required for PUCCH transmission of the MCG and is calculated based on parameters set by the higher layer, a downlink path loss, an adjustment value determined by the UCI transmitted in the PUCCH, an adjustment value determined by a PUCCH format, an adjustment value determined by the number of antenna ports used for the PUCCH transmission, a value based on a TPC command, and the like.

As step (s3), the following operation is performed.

If there is PUCCH transmission in the SCG (or, if terminal device 1 recognizes that there is PUCCH transmission in the SCG), the operation of P_{SCG}=P_{SCG}+δ₁+δ₂, P_{SeNB,Remaining}=P_{SeNB,Remaining}−δ₁, P_{Remaining}=P_{Remaining}−δ₂ is performed. Here, δ₁=min (P_{PUCCH,SCG}, P_{SeNB,Remaining}) and δ₂=min (P_{PUCCH,SCG}−δ₁, P_{Remaining}). That is, a power value required for the PUCCH transmission is allocated from surplus guarantee power of the SCG to the SCG. In this case, in a case where the surplus guarantee power of the SCG is insufficient for the power required for PUCCH transmission, an insufficient amount of power is allocated to the SCG using surplus power after all surplus guarantee power is allocated to the SCG. Here, when the surplus power is insufficient to the insufficient amount of power, all surplus power is allocated to the SCG. An amount the power value allocated from the surplus guarantee power or surplus power is added to the power value of SCG. The power value allocated to the SCG is subtracted from the surplus guarantee power or surplus power. The P_{PUCCH,SCG} is a power value required for PUCCH transmission of the SCG and is calculated based on parameters set by the higher layer, a downlink path loss, an adjustment value determined by the UCI transmitted in the PUCCH, an adjustment value determined by a PUCCH format, an adjustment value determined by the number of antenna ports used for PUCCH transmission, and a value based on TPC command.

As step (s4), the following operation is performed. If there is PUSCH transmission including the UCI in the MCG (or, if terminal device 1 recognizes that there is PUSCH transmission including the UCI in the MCG), the operation of P_{MCG}=P_{MCG}+δ₁+δ₂. P_{MeNB,Ramaining}=P_{MeNB,Remaining}−δ₁, P_{Remaining}=P_{Remaining}−δ₂ is performed. Here, δ₁=min (P_{PUSCH,j,MCG}, P_{MeNB,Remaining}) and δ₂=min (P_{PUSCH,j,MCG}−δ₁, P_{Remaining}). That is, a power value required for the PUSCH transmission including the UCI is allocated from surplus guarantee power of the MCG to the MCG. In this case, in a case where the surplus guarantee power of the MCG is insufficient for the power required for PUSCH transmission including the UCI, an insufficient amount of power is allocated to the MCG using surplus power after all surplus guarantee power is allocated to the MCG. Here, when the surplus power is insufficient to the insufficient amount of power, all surplus power is allocated to the MCG. An amount of the power value allocated from the surplus guarantee power or surplus power is added to the power value of MCG. The power value allocated to the MCG is subtracted from the surplus guarantee power or surplus power. The P_{PUSCH,j,MCG} is a power value required for PUSCH transmission including the UCI in the MCG and is calculated based on parameters set by the higher layer, an adjustment value determined by the number of PRBs assigned to the PUSCH transmission by resource assignment, a downlink path loss and a coefficient multiplied thereto, an adjustment value determined by parameter indicating offset of the MCS applied to the UCI, a value based on a TPC command, and the like.

As step (s5), the following operation is performed. If there is PUSCH transmission including the UCI in the SCG (or, if terminal device 1 recognizes that there is PUSCH transmission including the UCI in the SCG), the operation of P_{SCG}=P_{SCG}+δ₁+δ₂, P_{SeNB,Remaining}=P_{SeNB,Remaining}−δ₁, P_{Remaining}=P_{Remaining}−δ₂ is performed. Here, δ₁=min (P_{PUSCH,j,SCG}, P_{SeNB,Remaining}) and δ₂=min (P_{PUSCH,j,SCG}−δ₁, P_{Remaining}). That is, a power value required for the PUSCH transmission including the UCI is assigned from surplus guarantee power of the SCG to the SCG. In this case, in a case where the surplus guarantee power of the SCG is insufficient for the power required for PUSCH transmission including the UCI, an insufficient amount of power is allocated to the SCG using surplus power after all surplus guarantee power is allocated to the SCG. Here, when the surplus power is insufficient to the insufficient amount of power, all surplus power is allocated to the SCG. An amount of the power value allocated from the surplus guarantee power or surplus power is added to the power value of SCG. The power value allocated to the SCG is subtracted from the surplus guarantee power or surplus power. The P_{PUSCH,j,SCG} is a power value required for PUSCH transmission including the UCI in the SCG and is calculated based on parameters set by the higher layer, an adjustment value determined by the number of PRBs assigned to the PUSCH transmission by resource assignment, a downlink path loss and a coefficient multiplied thereto, an adjustment value determined by parameter indicating offset of the MCS applied to the UCI, a value based on TPC command, and the like.

As step (s6), the following operation is performed. If there is one or more PUSCH transmission (PUSCH transmission not including the UCI) in the MCG (or, if terminal device 1 recognizes that there is PUSCH transmission in the MCG), the operation of P_{MCG}=P_{MCG}+δ1+δ2, P_{MeNB,Remaining}=P_{MeNB,Remaining}−δ1, P_{Remaining}=P_{Remaining}−δ2 is performed. Here, δ1=min (ΣP_{PUSCH,c,MCG}, P_{MeNB,Remaining}) and δ2=min (ΣP_{PUSCH,c,MCG}−δ1, P_{Remaining}). That is, the sum of the power value required for the PUSCH transmission is allocated from surplus guarantee power of the MCG to the MCG. In this case, in a case where the surplus guarantee power of the MCG is insufficient for the sum of the power required for PUSCH transmission, an insufficient amount of power is allocated to the MCG using surplus power after all surplus guarantee power is allocated to the MCG. Here, in a case where the surplus power is insufficient to the insufficient amount of power, all surplus power is allocated to the MCG. An amount of the power value allocated from the surplus guarantee power or surplus power is added to the power value of MCG. The power value allocated to the MCG is subtracted from the surplus guarantee power or surplus power. The P_{PUSCH,c,MCG} is a power value required for PUSCH transmission of a serving cell c belongs to the MCG and is calculated based on parameters set by the higher layer, an adjustment value determined by the number of PRBs assigned to the PUSCH transmission by resource assignment, a downlink path loss and a coefficient multiplied thereto, a value based on TPC command, and the like. The Σ refers to total and ΣP_{PUSCH,c,MCG} represents a total value of P_{PUSCH,c,MCG} in which c≠j.

As step (s7), the following operation is performed. If there is one or more PUSCH transmission (PUSCH transmission not including the UCI) in the SCG (or, if terminal device 1 recognizes that there is PUSCH transmission in the MCG), the operation of P_{SCG}=P_{SCG}+δ₁+δ₂, P_{SeNB,Remaining}=P_{SeNB,Remaining}−δ₁, P_{Remaining}=P_{Remaining}−δ₂ is performed. Here, δ₁=min (ΣP_{PUSCH,c,SCG}, P_{SeNB,Remaining}) and δ₂=min (ΣP_{PUSCH,c,SCG}−δ₁, P_{Remaining}). That is, the sum of the power value required for the PUSCH transmission is assigned from surplus guarantee power of the SCG to the SCG. In this case, in a case where the surplus guarantee power of the SCG is insufficient for the sum of the power required for PUSCH transmission, an insufficient amount of power is allocated to the SCG using surplus power after all surplus guarantee power is allocated to the SCG. Here, in a case where the surplus power is insufficient to the insufficient amount of power, all surplus power is allocated to the SCG. An amount of the power value allocated from the surplus guarantee power or surplus power is added to the power value of SCG. The power value allocated to the SCG is subtracted from the surplus guarantee power or surplus power. The P_{PUSCH,c,SCG} is a power value required for PUSCH transmission of a serving cell c belongs to the SCG and is calculated based on parameters set by the higher layer, an adjustment value determined by the number of PRBs assigned to the PUSCH transmission by resource assignment, a downlink path loss and a coefficient multiplied thereto, a value based on TPC command, and the like. The Σ refers to total and ΣP_{PUSCH,c,SCG} represents a total value of P_{PUSCH,c,SCG} in which c≠j.

As step (s8), the following operation is performed. If a sub-frame to be subjected to a power calculation is a sub-frame of the MCG, P_{CMAX,CG}, which is the maximum output power value for the CG which becomes a target of the power calculation, is set as P_{CMAX,CG}=P_{MCG}. Otherwise, that is, if a sub-frame to be subjected to a power calculation is a sub-frame of the SCG, P_{CMAX,CG}, which is the maximum output power value for the CG which becomes a target of the power calculation, is set as P_{CMAX,CG}=P_{SCG}.

In this way, it is possible to calculate the maximum output power value in the CG which becomes a target of the power calculation from the guarantee power and surplus power. As initial values of the power value of the MCG, the power value of the SCG, the surplus power, and the surplus guarantee power in the respective steps, final values in the previous steps are used.

Here, priorities defined by PUCCH in the MCG, PUCCH in the SCG, PUSCH including the UCI in the MCG, PUSCH not including the UCI in the MCG. PUSCH not including the UCI in the SCG in this order are used as priorities for power allocation, but is not limited thereto. Other priorities may be used. For example, priorities may be defined by channel in the MCG including HARQ-ACK, channel in the SCG including HARQ-ACK, PUSCH (not including HARQ-ACK) in the MCG, and PUSCH (not including HARQ-ACK) in the SCG in this order. The priorities may be defined by channel including SR, channel (not including SR) including HARQ-ACK, channel including CSI (not including SR or HARQ-ACK), and channel including data (not including UCI) in this order without distinguishing between the MCG and the SCG. In these cases, required power values may be replaced in step s2 to step s7. In a case where a plurality of channels become the target in a single step, the sum of required power by the channels may be used as in step s6 and step s7. Alternatively, it is also possible to use a method in which some of the steps are not performed. Also, in addition to the above-mentioned channels, priorities may be given in consideration of the PRACH and SRS. In this case, a priority of PRACH may be higher than PUCCH and a priority of the SRS may be lower than PUSCH (not including UCI).

In the following, another method of allocation of the guarantee power and residual power will be described.

First, as a step (t1), a power value of the MCG, a power value of the SCG, surplus power (unallocated surplus power), total required power of the MCG, and total required power of the SCG are initialized. More specifically, it is set as P_{MCG}=0, P_{SCG}=0, P_{Remaining}=P_{CMAX}. It is set as P_{MCG,Required}=0, P_{SCG,Required}=0. Here, P_{MCG} and P_{SCG} are the power value of the MCG and the power value of the SCG, respectively and P_{Remaining} is a surplus power value. P_{CMAX}, P_{MeNB}, and P_{SeNB} are parameters described above. P_{MCG,Required} and P_{SCG,Required} are a total required power value required for transmitting channels within the MCG and a total required power value required for transmitting channels within the SCG, respectively. Here, each power value is a linear value.

Next, surplus power is sequentially allocated to each CG for PUCCH in the MCG, PUCCH in the SCG, PUSCH including UCI in the MCG, PUSCH not including the UCI in the MCG, PUSCH not including the UCI in the SCG in order. In this case, an amount of power to be sequentially allocated to each CG is basically a power value required for each channel (transmit power control (TPC) command, resource assignment, or the like). However, in a case where surplus power does not satisfy a required power value, all the surplus power is allocated. When power is allocated to the CG, surplus power is reduced by an amount of allocated power. The power value required for the channel is added to the total required power of the CG. The required power value is added regardless of whether surplus power is sufficient to a power value required for surplus power. In the following, (t2) to (t9) will be described as more specific power value calculation steps for each CG.

As step (t2), the following operation is performed. If there is PUCCH transmission in the MCG, the operation of P_{MCG}=P_{MCG}+δ, P_{MCG,Required}=P_{MCG,Required}−P_{PUCCH,MCG}, P_{Remaining}=P_{Remaining}−δ is performed. Here, δ=min (P_{PUCCH,MCG}, P_{Remaining}). That is, a power value required for the PUCCH transmission is allocated from surplus power to the MCG. In this case, in a case where the surplus power is insufficient for the power required for PUCCH transmission, all of surplus power are added to the MCG. The power value required for the PUCCH transmission is added to the total required power value of the MCG. The power value allocated to the MCG is subtracted from the surplus power.

As step (t3), the following operation is performed. If there is PUCCH transmission in the SCG, the operation of P_{SCG}=P_{SCG}+δ, P_{SCG,Required}=P_{SCG,Required}−P_{PUCCH,SCG}, P_{Remaining}=P_{Remaining}−δ is performed. Here, δ=min (P_{PUCCH,SCG}, P_{Remaining}). That is, a power value required for the PUCCH transmission is allocated from surplus power to the SCG. In this case, in a case where the surplus power is insufficient for the power required for PUCCH transmission, all of surplus power are added to the MCG. The power value required for the PUCCH transmission is added to the total required power value of the SCG. The power value allocated to the SCG is subtracted from the surplus power.

As step (t4), the following operation is performed. If there is PUSCH transmission including the UCI in the MCG, the operation of P_{MCG}=P_{MCG}+δ, P_{MCG,Required}=P_{MCG,Required}−P_{PUSCH,j,MCG}, P_{Remaining}=P_{Remaining}−δ is performed. Here, δ=min (P_{PUSCH,j,MCG}, P_{Remaining}). That is, a power value required for the PUSCH transmission including the UCI is allocated from surplus power to the MCG. In this case, in a case where the surplus power is insufficient for the power required for PUSCH transmission including the UCI, all of surplus power is added to the MCG. The power value required for the PUCCH transmission including the UCI is added to the total required power value of the MCG. The power value allocated to the MCG is subtracted from the surplus power.

As step (t5), the following operation is performed. If there is PUSCH transmission including the UCI in the SCG, the operation of P_{SCG}=P_{SCG}+δ, P_{SCG,Reqiured}=P_{SCG,Required}−P_{PUSCH,j,SCG}, P_{Remaining}=P_{Remaining}−δ is performed. Here, δ=min (P_{PUSCH,j,SCG}, P_{Remaining}). That is, a power value required for the PUSCH transmission including the UCI is allocated from surplus power to the SCG. In this case, in a case where the surplus power is insufficient for the power required for PUSCH transmission including the UCI, all of surplus power is added to the SCG. The power value required for the PUSCH transmission including the UCI is added to the total required power value of the SCG. The power value allocated to the SCG is subtracted from the surplus power.

As step (t6), the following operation is performed. If there is one or more PUSCH transmission (PUSCH transmission including the UCI) in the MCG, the operation of P_{MCG}=P_{MCG}+δ, P_{MCG,Required}=P_{MCG,Required}−ΣP_{PUSCH,c,MCG}, P_{Remaining}=P_{Remaining}−δ is performed. Here, δ=min (ΣP_{PUSCH,c,MCG}, P_{Remaining}). That is, the sum of the power value required for the PUSCH transmission is assigned from surplus power to the MCG. In this case, in a case where the surplus power is insufficient for the sum of power required for PUSCH transmission, all of surplus power are added to the MCG. An amount of power value allocated from surplus power is added to the power value of the MCG. The sum of the power value required for the PUSCH transmission is added to the total required power value of the MCG. The power value allocated to the MCG is subtracted from the surplus power.

As step (t7), the following operation is performed. If there is one or more PUSCH transmission (PUSCH transmission including the UCI) in the SCG, the operation of P_{SCG}=P_{SCG}+δ, P_{SCG,Required}=P_{SCG,Required}−Σ_{PUSCH,c,SCG}. P_{Remaining}=P_{Remaining}−δ is performed. Here, δ=min (ΣP_{PUSCH,c,SCG}, P_{Remaining}). That is, the sum of the power value required for the PUSCH transmission is assigned from surplus power to the SCG. In this case, in a case where the surplus power is insufficient for the sum of power required for PUSCH transmission, all of surplus power are added to the SCG. An amount of power value allocated from surplus power is added to the power value of the SCG. The sum of the power value required for the PUSCH transmission is added to the total required power value of the SCG. The power value allocated to the SCG is subtracted from the surplus power.

In step (t8), it is checked whether a power value allocated to each CG is greater than or equal to guarantee power (or not less than). It is checked whether the power value allocated to each CG is equal to a total required power value (or not less than) (that is, whether a channel of which surplus power value not satisfying required power value exists among channels in the CG). In a case where it is not greater than or equal to guarantee power (less than guarantee power) in a certain CG (CG1) and in a case where it is not equal to the total required power value (less than the total required power value), an insufficient amount of power is allocated to a CG (CG1) from the power value allocated to another CG (CG2). The insufficient amount of power is subtracted from the final power value of another CG (CG2), which results in a value obtained by subtracting the guarantee power value of the CG1 from P_{CMAX}. With this, in a case where the required power is satisfied in a certain CG, the guarantee power may not be satisfied and thus, it is possible to efficiently utilize power. As a more specific example, the operations such as step (t8-1) and step (t8-2) are performed.

As step (t8-1), if P_{MCG}<P_{MeNB} and P_{MCG}<P_{MCG,Required}, it is set as P_{MCG}=P_{MeNB}, and it is set as P_{SCG}=P_{CMX}−P_{MCG} (that is, P_{SCG}=P_{CMAX}−P_{MeNB}).

As step (t8-2), if P_{SCG}<P_{SeNB} and P_{SCG}<P_{SCG,Required} (if the condition of step (t8-1) is not satisfied, P_{SCG}<P_{SNB}, and P_{SCG}<P_{SCG,Required}), it is set as P_{SCG}=P_{SeNB}, and it is set as P_{MCG}=P_{CMAX}−P_{SCG} (that is, P_{MCG}=P_{CMAX}−P_{SeNB}).

As step (t9), the following operation is performed. If a sub-frame to be subjected to a power calculation is a sub-frame of the MCG, P_{CMAX,CG}, which is the maximum output power value for the CG which becomes a target of the power calculation, is set as P_{CMAX,CG}=P_{MCG}. Otherwise, that is, if a sub-frame to be subjected to a power calculation is a sub-frame of the SCG, P_{CMAX,CG}, which is the maximum output power value for the CG which becomes a target of the power calculation, is set as P_{CMAX,CG}=P_{SCG}.

By doing as described above, it is possible to calculate the maximum output power value in the CG which becomes a target from the guarantee power and surplus power. As initial values of the power value of the MCG, the power value of the SCG, the surplus power, the total required power of the MCG, and the total required power of the SCG in the respective steps, final values in the previous steps are used.

In addition, instead of step (t8), the following steps (step (t10)) may be performed. That is, it is checked whether a power value allocated to each CG is greater than or equal to guarantee power (or not less than). In a case where it is not greater than or equal to guarantee power (less than guarantee power) in a certain CG (CG1), an insufficient amount of power is allocated to a CG (CG1) from the power value allocated to another CG (CG2). The insufficient amount of power is subtracted from the final power value of another CG (CG2), which results in a minimum value between a value obtained by subtracting the guarantee power value of the CG1 from P_{CMAX} and the total required power value of the CG2. With this, in each CG, it is possible to always acquire guarantee power and thus, stable communication can be performed. As a more specific example, the operations such as step (t10-1) and step (t10-2) are performed.

As step (t10-1), if P_{MCG}<P_{MeNB}, it is set as P_{MCG}=P_{MeNB}, and it is set as P_{SCG}=min (P_{SCG,Required}, P_{CMAX}−P_{MeNB}).

As step (t10-2), if P_{SCG}<P_{SeNB}, it is set as P_{SCG}=P_{SeNB}, and it is set as P_{MCG}=min (P_{MCG,Required}, P_{CMAX}−P_{SeNB}).

Here, priorities defined by PUCCH in the MCG, PUCCH in the SCG, PUSCH including the UCI in the MCG, PUSCH not including the UCI in the MCG, PUSCH not including the UCI in the SCG in this order are used as priorities for power allocation, but is not limited thereto. Other priorities (for example, priorities described above) may also be used.

So far, an allocation method of guarantee power and residual power for determining the maximum output power value for each CG has been described. In the following, a power distribution within the CG under the maximum output power value for each CG will be described.

First, the power distribution within the CG in a case where dual connectivity is not set will be described.

In a case where it is considered that the total transmit power of the terminal device 1 exceeds P_{CMAX}, the terminal device 1 scales P_{PUSCH,c} in the serving cell c such that the condition of Σ(wP_{PUSCH,c})≦(P_{CMAX}−P_{PUCCH}) is satisfied. Here, w is a scaling factor for the serving cell c (coefficient to be multiplied to the power value) and take a value greater than or equal to 0 and less than or equal to 1. In a case where there is no PUCCH transmission, it is assumed that P_{PUCCH}=0.

In a case where the terminal 1 performs PUSCH transmission including the UCI in a certain serving cell j and PUSCH transmission not including the UCI is performed in any of the remaining serving cells, and it is considered that the total transmit power of the terminal device 1 exceeds P_{CMAX}, the terminal device 1 scales P_{PUSCH,c} in the serving cell c not including the UCI such that the condition of Σ(w_{PPUSCH,c})≦(P_{CMAX}−P_{PUSCH,j}) is satisfied. However, the left side is the total sum of the serving cells c other than the serving cell j. Here, w is a scaling factor for the serving cell c that does not include the UCI. Here, as long as Σ(wP_{PUSCH,c})=0 and the total transmit power of the terminal device 1 does not still exceed P_{CMAX}, a power factor is not applied to PUSCH including the UCI. However, although when w>0, w is a common value for respective serving cells, w may also be zero for a certain serving cell. In this case, it means that channel transmission in the serving cell is dropped.

In a case where the terminal 1 performs simultaneous transmissions of PUCCH and PUSCH including the UCI in the certain serving cell j, PUSCH transmission not including the UCI is performed in any of the remaining serving cells, and it is considered that the total transmit power of the terminal device 1 exceeds P_{CMAX}, the terminal device 1 obtains P_{PUSCH,c} based on P_{PUSCH,j}=min (P_{PUSCH,j}, (P_{CMAX}−P_{PUCCH})) and Σ(w_{PUSCH,c})≦(P_{CMAX}−P_{PUCCH}−P_{PUSCH,j}). That is, the power of PUCCH is reserved first and the power of PUSCH including the UCI is calculated from the residual power. In this case, in a case where the residual power is greater than the required power of PUSCH including the UCI (P_{PUSCH,j} of the right side of the first expression), the required power of PUSCH including the UCI is set as power of PUSCH including the UCI (P_{PUSCH,j} of the left side of the first expression, that is, actual power value of PUSCH including the UCI) and in a case where the residual power is less than/equal to the required power for PUSCH including the UCI, all of the residual powers are set as power of PUSCH including the UCI. The residual power obtained by subtracting the power of PUCCH and the power of PUSCH including the UCI is allocated to PUSCH not including UCI. In this case, scaling is performed as needed.

If a plurality of timing advance groups (TAGs) are set in the terminal device 1 and the PUCCH/PUSCH transmission of the terminal device 1 in a sub-frame i for a certain serving cell in a single TAG overlaps a portion of first symbols of PUSCH transmission of a sub-frame i+1 for a different serving cell in other TAGs, the terminal device 1 also adjusts the total transmit power so as not to exceed P_{CMAX} in any overlapped portion. Here, the TAG is a group of serving cells for adjusting the uplink transmission timing for the downlink reception timing. One or more serving cells belong to a single TAG and common adjustment is applied to one or more serving cells in a single TAG.

If a plurality of TAGs are set in the terminal device 1 and the PUSCH transmission of the terminal device 1 in a sub-frame i for a certain serving cell in a single TAG overlaps a portion of first symbols of PUCCH transmission of a sub-frame i+1 for a different serving cell in other TAGs, the terminal device 1 also adjusts the total transmit power so as not to exceed P_{CMAX} in any overlapped portion.

If a plurality of TAGs are set in the terminal device 1 and SRS transmission of the terminal device 1 in a single symbol of a sub-frame i for a certain serving cell in a single TAG overlaps PUCCH/PUSCH transmission of a sub-frame i or a sub-frame i+1 for a different serving cell in other TAGs, the terminal device 1 drops the SRS transmission when the total transmit power exceeds the P_{CMAX} in any overlapped portion of the symbol.

If a plurality of TAGs and more than two serving cells are set in the terminal device 1 and SRS transmission of the terminal device 1 in a single symbol of a sub-frame i for a certain serving cell overlaps SRS transmission of a sub-frame i for a different serving cell and PUCCH/PUSCH transmission of a sub-frame i or sub-frame i+1 for a different serving cell, the terminal device 1 drops the SRS transmission when the total transmit power exceeds the P_{CMAX} in any overlapped portion of the symbol.

If a plurality of TAGs are set in the terminal device 1, when PRACH transmission in a secondary serving cell is requested to be transmitted in parallel with SRS transmission in a symbol of a sub-frame of a different serving cell that belongs to a different TAG in a higher layer, the terminal device 1 drops the SRS transmission when the total transmit power exceeds the P_{CMAX} in any overlapped portion of the symbol.

If a plurality of TAGs are set in the terminal device 1, when PRACH transmission in a secondary serving cell is requested to be transmitted in parallel with PUSCH/PUCCH transmission in a sub-frame of a different serving cell that belongs to a different TAG in a higher layer, the terminal device 1 adjusts transmit power of PUSCH/PUCCH such that the total transmit power does not exceed P_{CMAX} in the overlapped portion.

Next, the power distribution within the CG in a case where dual connectivity is set will be described.

In a case where it is considered that the total transmit power in a certain CG of the terminal device 1 exceeds P_{CMAX,CG}, the terminal device 1 scales P_{PUSCH,c} in a serving cell c of the CG such that the condition of P_{PUCCH}=min (P_{PUCCH}, P_{CMAX,CG}) is satisfied and Σ(wP_{PUSCH,c})≦(P_{CMAX,CG}−P_{PUCCH}). That is, in a case where the maximum output power value of the CG is greater than the required power of PUCCH (P_{PUCCH} of the right side of the first expression), the required power of PUCCH is set as power of PUCCH (P_{PUCCH} of the left side of the first expression, that is, actual power value of PUCCH) and in a case where the maximum output power value of the CG is less than/equal to the required power of PUCCH, all of the maximum output power values of the CG are set as power of PUCCH. The residual power obtained by subtracting the power of PUCCH from P_{CMAX,CG} is allocated to PUSCH. In this case, scaling is performed as needed. If there is no PUCCH transmission in the CG, it is set as P_{PUCCH}=0. P_{PUCCH} of the right side of the second expression is P_{PUCCH} calculated by the first expression.

In a case where the terminal 1 performs PUSCH transmission including the UCI in a certain serving cell j in a certain CG, PUSCH transmission not including the UCI is performed in any of the remaining serving cells in a certain CG, and it is considered that the total transmit power of the terminal device 1 in a certain CG exceeds P_{CMAX,CG}, the terminal device 1 scales P_{PUSCH,c} in the serving cell c not including the UCI such that the condition of P_{PUSCH,j}=min (P_{PUSCH,j}, (P_{CMAX,CG}−P_{PUSCH})) is satisfied and Σ(wP_{PUSCH,c})≦(P_{CMAX,CG}−P_{PUSCH,j}). However, the left side of the second expression is the total sum in serving cells c other than the serving cell j. The P_{PUSCH,j} of the right side of the second expression is P_{PUSCH,j} calculated in the first expression.

In a case where the terminal 1 performs simultaneous transmissions of PUCCH and PUSCH including the UCI in the certain serving cell j in a certain CG, PUSCH transmission not including the UCI is performed in any of the remaining serving cells, and it is considered that the total transmit power of the terminal device 1 in the CG exceeds P_{CMAX,CG}, the terminal device 1 obtains P_{PUSCH,c} based on P_{PUCCH}=min (P_{PUCCH}, P_{CMAX,CG}), P_{PUSCH,j}=min (P_{PUSCH,j}, (P_{CMAX,CG}−P_{PUCCH})), and Σ(wP_{PUSCH,c})≦(P_{CMAX,CG}−P_{PUCCH}−P_{PUSCH,j}). That is, the power of PUCCH is reserved from the maximum output power of the CG first and then, the power of PUSCH including the UCI is calculated from the residual power. In this case, in a case where the maximum output power of the CG is greater than the required power of PUCCH, the required power of PUCCH is set as transmit power of PUSCH and in a case where the maximum output power of the CG is less than/equal to the required power for PUCCH, the required power of PUCCH is set as transmit power of PUCCH of the maximum output power of the CG. Similarly, in a case where the residual power is greater than the required power of PUSCH including the UCI, the required power of PUSCH including the UCI is set as transmit power of PUSCH including the UCI. In a case where the residual power is less than/equal to the required power for PUSCH including the UCI, all of the residual powers are set as transmit power of PUSCH including the UCI. The residual power obtained by subtracting the power of PUCCH and the power of PUSCH including the UCI is allocated to PUSCH not including UCI. In this case, scaling is performed as needed.

Processing similar to a case where dual connectivity is not set may be performed for dropping of power regulation or SRS in a case where a plurality of TAGs are set. In this case, it is preferable to perform similar processing for a plurality of TAGs within the CG and also perform similar processing for a plurality of TAGs within different CGs. Alternatively, the following processing may be performed. Alternatively, both of the processing may be performed.

If a plurality of TAGs in a single CG are set in the terminal device 1 and the PUCCH/PUSCH transmission of the terminal device 1 in a sub-frame i for a certain serving cell in a single TAG in the CG overlaps a portion of first symbols of PUSCH transmission of a sub-frame i+1 for a different serving cell in other TAGs in the CG, the terminal device 1 also adjusts the total transmit power so as not to exceed P_{CMAX,CG} of the CG in any overlapped portion.

If a plurality of TAGs in a single CG are set in the terminal device 1 and the PUSCH transmission of the terminal device 1 in a sub-frame i for a certain serving cell in a single TAG in the CG overlaps a portion of first symbols of PUCCH transmission of a sub-frame i+1 for a different serving cell in other TAGs in the CG, the terminal device 1 also adjusts the total transmit power so as not to exceed P_{CMAX,CG} of the CG in any overlapped portion.

If a plurality of TAGs in a single CG are set in the terminal device 1 and SRS transmission of the terminal device 1 in a single symbol of a sub-frame i for a certain serving cell in a single TAG of the CG overlaps PUCCH/PUSCH transmission of a sub-frame i or a sub-frame i+1 for a different serving cell in other TAGs within the CG, the terminal device 1 drops the SRS transmission when the total transmit power exceeds P_{CMAX,CG} of the CG in any overlapped portion of the symbol.

If a plurality of TAGs and more than two serving cells within a single CG are set in the terminal device 1 and SRS transmission of the terminal device 1 in a single symbol of a sub-frame i for a certain serving cell within the CG overlaps SRS transmission of a sub-frame i for a different serving cell within the CG and PUCCH-PUSCH transmission of a sub-frame i or sub-frame i+1 for a different serving cell within the CG, the terminal device 1 drops the SRS transmission when the total transmit power exceeds the P_{CMAX,CG} of the CG in any overlapped portion of the symbol.

If a plurality of TAGs in a single CG are set in the terminal device 1, when PRACH transmission in a secondary serving cell within the CG is requested to be transmitted in parallel with SRS transmission in a symbol of a sub-frame of a different serving cell that belongs to a different TAG within the CG in a higher layer, the terminal device 1 drops the SRS transmission when the total transmit power exceeds the P_{CMAX,CG} of the CG in any overlapped portion of the symbol.

If a plurality of TAGs within a single CG are set in the terminal device 1, when PRACH transmission in a secondary serving cell within the CG is requested to be transmitted in parallel with PUSCH/PUCCH transmission in a sub-frame of a different serving cell that belongs to a different TAG within the CG in a higher layer, the terminal device 1 adjusts transmit power of PUSCH/PUCCH such that the total transmit power does not exceed P_{CMAX,CG} of the CG in the overlapped portion.

Next, description will be made on operations of the terminal device 1 in a case where a radio link failure (RLF) occurs in a secondary cell. Two phases are present in the RLF. The first phase is a phase which is started at the time of radio problem detection. In the first phase, in a case where a failure is not recovered during a prescribed timer T1, it becomes the second phase after expiration of the prescribed timer T1. In the second phase, in a case where the failure is not recovered during a prescribed timer T2, it becomes the RRC idle state (RRC_idle) after expiration of the prescribed timer T2.

Description will be made on operations of the terminal device 1 in a case where a radio link failure (RLF) occurs in a secondary cell, but is not limited to the secondary cell. For example, in the following description, a case where a radio link failure (RLF) occurs in some or all of the secondary cells is included. In the following description, a case where a radio link failure (RLF) occurs in some of a group of the primary cell or all of the secondary cells is included. In the following description, a case where a radio link failure (RLF) occurs in some of a group of the primary cell or all of the secondary cells is included.

In the second phase, in a case where the terminal device 1 returns to the same cell or selects a different cell, the terminal device 1 is able to perform the following operations. The terminal device 1 holds an RRC connection state (RRC_connected).

The terminal device 1 accesses in a random access procedure. The terminal device 1 performs re-authentication of the terminal device 1 with an identification number of the terminal device 1 used in the random access procedure of conflict resolution and confirm whether a context used in the terminal device 1 is stored. If the context is present in the base station apparatus, the base station apparatus is able to resume connection to the terminal device 1. If the context is absent in the base station apparatus, RRC connection is released. The terminal device 1 is resumed from the RRC idle state in order to start a new RRC connection. Here, the identification number of the terminal device 1 is information (number, identification information, ID) identified by C-RNTI, a physical layer ID, and/or MAC.

A plurality of prescriptions for RLF detection (RLF triggering) may be defined. For example, the RLF detection may be based on the notification from radio link control (RLC) in a case where the maximum number of retransmissions reaches a prescribed number. The RLF detection may be based on a case where a prescribed timer T310 expires. In a case where consecutive out-of-sync notifications are received from a lower layer (physical layer) a prescribed number of times, the prescribed timer T310 starts. The RLF detection may be based on random access problem notifications from a media access control (MAC) layer while any of the prescribed timers T300. T301, T304, or T311 is not counted (not running, not moving). In the RLF detection, information on the RLF detection may be notified to the base station apparatus from the terminal device 1.

In a case where the secondary cell becomes a prescribed state related to the RLF, the terminal device 1 performs a prescribed operation.

As an example of the prescribed operation, the terminal device 1 releases PseNs in a case where the secondary cell becomes a prescribed state related to the RLF. That is, the terminal device 1 releases guarantee power for the secondary cell from RRC.

As another example of the prescribed operation, the terminal device 1 sets PseNB as a prescribed value in a case where the secondary cell becomes a prescribed state related to the RLF. The prescribed value may be a predefined value and, for example, 0%. The prescribed value may be a value set from the upper layer.

As another example of the prescribed operation, the terminal device 1 releases the P_{MeNB} and P_{SeNB} in a case where the secondary cell becomes a prescribed state related to the RLF. That is, the terminal device 1 releases guarantee power for the primary cell and guarantee power for the secondary cell from RRC.

As another example of the prescribed operation, the terminal device 1 sets P_{MeNB} and P_{SeNB} as a prescribed value in a case where the secondary cell becomes a prescribed state related to the RLF. The prescribed value may be a predefined value and, for example, 0%. The prescribed value may be a value set from the upper layer. The prescribed value may be independent in the P_{MeNB} and P_{SeNB}. The prescribed value may be 100% for the P_{MeNB} and 0% for the P_{SeNB}.

An example of a prescribed state related to the RLF, the prescribed state related to the RLF corresponds to a case where the terminal device 1 detects RLF (triggers RLF). As another example of the prescribed state related to the RLF, a prescribed state related to the RLF corresponds to a case where the terminal device 1 enters the first phase. As another example of the prescribed state related to the RLF, a prescribed state related to the RLF corresponds to a case where the terminal device 1 ends the first phase. As another example of the prescribed state related to the RLF, a prescribed state related to the RLF corresponds to a case where the terminal device 1 enters the second phase. As another example of the prescribed state related to the RLF, a prescribed state related to the RLF corresponds to a case where the terminal device 1 ends the second phase. As another example of the prescribed condition related to the RLF, a prescribed state related to the RLF correspond s to a case where the terminal device 1 becomes RRC idle state.

As such, even in a case where dual connectivity is set, it is possible to efficiently perform transmit power control between cell groups.

In the embodiment described above, description is made in such a way that a power value required for each PUSCH transmission is calculated based on parameters set by the higher layer, an adjustment value determined by the number of PRBs assigned to the PUSCH transmission by resource assignment, a downlink path loss and a coefficient multiplied thereto, an adjustment value determined by parameter indicating offset of the MCS applied to the UCI, a value based on a TPC command, and the like. Further, description is made in such a way that a power value required for each PUCCH transmission is calculated based on parameters set by the higher layer, a downlink path loss, an adjustment value determined by the UCI transmitted in the PUCCH, an adjustment value determined by a PUCCH format, an adjustment value determined by the number of antenna ports used for the PUCCH transmission, a value based on a TPC command, and the like. However, it is not limited thereto. An upper limit value may be provided for the required power value and a minimum value between a value based on the parameter and an upper limit value (for example, P_{CMAX,c} which is the maximum output power value in a serving cell c) may also be used as the required power value.

In the embodiment described above, description is made on a case where serving cells are grouped in a connectivity group, but is not limited thereto. For example, in a plurality of serving cells, only downlink signals may be grouped or only uplink signals may be grouped. In this case, connectivity identifiers may be set for the downlink signals or the uplink signals. The downlink signals and uplink signals may be individually grouped. In this case, the connectivity identifiers may be individually set for the downlink signals and the uplink signals, respectively. Alternatively, downlink component carriers may be grouped or uplink component carriers may be grouped. In this case, the connectivity identifiers may be individually set for respective component carriers.

In the respective embodiments described above, description is made using the connectivity group, but it is not always necessary to define a set of serving cells provided by the same base station apparatus (transmission point) in a connectivity group. Instead of the connectivity group, the set of serving cells may be defined by using a connectivity identifier or a cell index. For example, in a case where the set of serving cells is defined by the connectivity identifier, the connectivity group in the respective embodiments described above may be referred to as a set of serving cells having the same connectivity identifier value. Alternatively, in a case where the set of serving cells is defined by the cell index, the connectivity group in the respective embodiments described above may be referred to as a set of serving cells of which a value of the cell index is a prescribed value (or prescribed range).

In the respective embodiments described above, description is made using terms of a primary cell or a PScell, but it is not always necessary to use the terms. For example, the primary cell may be referred to as a master cell in the respective embodiments described above and the PScell may be referred to as a primary cell. In the respective embodiments, the PScell may be called a primary cell.

A program running on the base station apparatus 2-1 or the base station apparatus 2-2 and the terminal device 1 according to the present invention may be a program (program causing computer to function) that controls a central processing unit (CPU) or the like so as to realize functions of the above embodiments according to the present invention. The information handled by the devices is temporarily accumulated in a random access memory (RAM) during processing of the devices, stored thereafter in various ROMs such as a flash read only memory (ROM) or a hard disk drive (HDD), and read, modified, and written by the CPU as needed.

A portion of the terminal device 1 and the base station apparatus 2-1 or the base station apparatus 2-2 in the embodiment described above may be realized by a computer.

In this case, a program for realizing control functions may be recorded in a recording medium readable by a computer, the program recorded in the recording medium may be read into a computer system to realize the functions by executing the program.

Here, the “computer system” referred to herein may be a computer system incorporated in the terminal device 1, the base station apparatus 2-1, or the base station apparatus 2-2, and includes an OS and hardware of peripheral devices and the like. The “computer readable recording memory” refers to a portable medium such as a flexible disk, a magneto-optical disk, a ROM, and a CD-ROM and a storage device such as a hard disk built in the computer system.

Furthermore, the “computer readable recording memory” may include a matter, such as a communication line, holding dynamically a program in a short period of time in a case where the program is transmitted through a network such as the Internet or a communication line such as a telephone line and a matter, such as a volatile memory, which becomes a server or a client in such a case, inside the computer system, holding the program for a fixed period of time. The program may be one for realizing a portion of the functions described above and may also be one capable of realizing the above-described functions by a combination of the program recorded already in the computer system.

The base station apparatus 2-1 or the base station apparatus 2-2 in the embodiment described above may also be realized as an assembly (device group) constituted with a plurality of devices. Each of the devices constituting the device group may also include respective functions or some or all of functional blocks of the base station apparatus 2-1 or the base station apparatus 2-2 according to the embodiment described above. The device group needs to have respective functions or respective functional blocks of a series of base station apparatuses 2-1 or base station apparatuses 2-2. The terminal device 1 according to the embodiment described above is able to communicate with the base station apparatus as an assembly.

In the above embodiment, the base station apparatus 2-1 or the base station apparatus 2-2 may be an evolved universal terrestrial radio access network (EUTRAN). In the embodiment described above, the base station apparatus 2-1 or the base station apparatus 2-2 may include some or all of the functions of a higher node of an eNodeB.

In the embodiment described above, same or all of the terminal device 1, the base station apparatus 2-1, or the base station apparatus 2-2 may be typically realized as an LSI which is an integrated or may be realized as a chipset. Respective functional blocks of the terminal device 1, the base station apparatus 2-1, or the base station apparatus 2-2 may be separately formed into a chip, or some or all of functional blocks may be formed into a chip. A circuit integration scheme is not limited to an LSI and may be realized by dedicated circuits or a general purpose processor. In a case where a circuit integration technology to replace the LSI appears as the semiconductor technology is progressed, it is also possible to use an integrated circuit according to the technology.

In the embodiment described above, a cellular mobile station apparatus is described as an example of a terminal device or a communication device, but the present invention is not limited thereto and may also be applied to stationary, or non-movable electronic devices placed indoors or outdoors, for example, a terminal device or a communication device of AV equipment, kitchen equipment, cleaning and washing equipment, air-conditioning equipment, office equipment, vending machines, other living appliance, and the like.

Although embodiments of the present invention have been described with reference to drawings, a specific configuration of the invention is limited to the embodiments and also includes design alteration in a range not departing from a gist of invention. Various changes may be made to the present invention within the scope set forth in the claims and an embodiment obtained by appropriately combine technology means disclosed in different embodiments is also included in the technical scope of the present invention. A configuration in which elements described in respective elements and elements achieving the same effect are replaced with each other is included in the technical scope of the present invention.

### INDUSTRIAL APPLICABILITY

The present invention can be applied to a stationary, non-movable electronic device, living appliance, or the like placed indoors or outdoors in addition to a communication device including a terminal device or a base station apparatus.

### DESCRIPTION OF REFERENCE NUMERALS

501 higher layer
502 control unit
503 code word generation unit
504 downlink sub-frame generation unit
505 downlink reference signal generation unit
506 OFDM signal transmission unit
507 transmit antenna
508 receive antenna
509 SC-FDMA signal reception unit
510 uplink sub-frame processing unit
511 uplink control information extraction unit
601 receive antenna
602 OFDM signal reception unit
603 downlink sub-frame processing unit
604 downlink reference signal extraction unit
605 transport block extraction unit
606, 1006 control unit
607, 1007 higher layer
608 channel state measurement unit
609, 1009 uplink sub-frame generation unit
610 uplink control information generation unit
611, 612, 1011 SC-FDMA signal transmission unit
613, 614, 1013 transmit antenna

1. A terminal device that communicates with a base station apparatus, comprising:
a higher layer processing unit that configures a first cell group and a second cell group; and
an uplink sub-frame generation unit forming a physical uplink channel in the first cell group that overlaps the second cell group in a certain sub-frame,
wherein in a case where a Radio Link Failure (RLF) is detected in the second cell group, the higher layer processing unit performs prescribed processing to the physical uplink channel in the second cell group.

2. The terminal device according to claim 1,
wherein the prescribed processing releases settings in the second cell group.

3. The terminal device according to claim 1,
wherein the prescribed processing makes power of the physical uplink channel 0.

4. A base station apparatus that communicates with a terminal device, comprising:
a higher layer processing unit configured to set a first cell group and a second cell group in the terminal device; and
an uplink sub-frame generation unit generating a physical uplink channel in the first cell group that overlaps the second cell group in a certain sub-frame,
wherein in a case where a Radio Link Failure (RLF) is detected in the second cell group, the higher layer processing unit performs prescribed processing to the physical uplink channel in the second cell group.

5. The base station apparatus according to claim 4,
wherein the prescribed processing releases settings in the second cell group.

6. The base station apparatus according to claim 4,
wherein the prescribed processing makes power of the physical uplink channel 0.

7. A communication method used by a terminal device that communicates with a base station apparatus, the method comprising:
a step of setting a first cell group and a second cell group; and
a step of generating a physical uplink channel in the first cell group that overlaps the second cell group in a certain sub-frame,
wherein in a case where a Radio Link Failure (RLF) is detected in the second cell group, the higher layer processing unit performs prescribed processing to the physical uplink channel in the second cell group.

8. A communication method used by a base station apparatus that communicates with a terminal device, the method comprising:
a step of setting a first cell group and a second cell group in the terminal device; and
a step of generating a physical uplink channel in the first cell group that overlaps the second cell group in a certain sub-frame,
wherein in a case where a Radio Link Failure (RLF) is detected in the second cell group, the higher layer processing unit performs prescribed processing to the physical uplink channel in the second cell group.
